(19) United States
(12) Patent Application Publication
(10) Pub. No.: US 2011/0246230 A1
(43) Pub. Date: Oct. 6, 2011

(54) Identity Matching And Information Linking

(75) Inventors: Yu Lin Sie, Bellevue, WA (US); VenkataChari SampathKumar, Sammamish, WA (US); Pranavakumar Punniamoorthy, Redmond, WA (US); Matthew Bordenet, Sammamish, WA (US); Sean Nolan, Bellevue, WA (US); Muzammil Ahmed, Seattle, WA (US)

(73) Assignee: Microsoft Corporation, Redmond, WA (US)

(21) Appl. No.: 12/751,805

(22) Filed: Mar. 31, 2010

(51) Int. Cl. G06F 17/30; G06Q 50/00; G06F 3/048

(52) U.S. Cl. 705/3; 707/769; 707/802; 707/781; 715/780; 707/E17.014; 707/E17.005

(57) ABSTRACT

A connection component establishes an identity of a person for permitting access to information in a database. Responsive to establishing the identity of the person, the connection component may link an external account to the information in the database for providing a flow of information between the database and the external account.

### BACKGROUND

Hospitals typically use enterprise database systems to maintain records of patient visits to the hospital. When a patient is released from the hospital, the hospital may provide information to the patient regarding the patient's visit and any follow-up care, medications prescribed, lab reports, information and instructions for the patient's personal doctor, or the like. Traditionally, if this information is made available to the patient, the information is printed onto paper and provided to the patient when the patient is discharged. Oftentimes, the information provided at discharge is incomplete and may merely include a portion of the information desired by the patient or the patient's personal care providers.

In addition, hospital databases that contain patient information are typically secure databases having limited accessibility so as to protect the personal medical information of patients and also maintain the integrity of the patient records. Consequently, electronic access to patient information contained in hospital databases by patients or others authorized by the patient is usually not permitted by the hospital or database provider. This practice can limit the ability of the patient and the patient's care providers to obtain desirable or vital patient information.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations disclosed herein enable a user to submit identification information for identity matching to obtain electronic access to information in a database. Additionally, some implementations provide for linking of information in a database to an external account of a user.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 depicts a block diagram of an example framework for a connection component according to some implementations disclosed herein.

FIG. 2 depicts a flow diagram of an example process for employing a connection component to access information in a database according to some implementations.

FIGS. 3A-3B depict block diagrams of examples of systems for accessing patient information according to some implementations disclosed herein.

FIG. 4 depicts an example of a patient identification information interface for submitting a match request according to some implementations.

FIG. 5 depicts an example of a patient matching request list according to some implementations.

FIG. 6A depicts an example of a patient matching interface according to some implementations.

FIG. 6B depicts an example of a link request denial interface according to some implementations.

FIG. 7 depicts an example of selection of manual or automatic matching linking according to some implementations.

FIG. 8 depicts an example of an account settings page according to some implementations.

FIGS. 9A-9B depict examples of block diagrams illustrating patient matching customization according to some implementations.

FIG. 10 depicts an example of a block diagram illustrating automatic matching and linking according to some implementations.

FIG. 11 depicts an example of a block diagram illustrating matching and linking with staff oversight according to some implementations.

FIGS. 12A-12B depict an example of a block diagram illustrating account relationships according to some implementations.

FIG. 13 depicts an example system architecture according to some implementations.

FIG. 14 depicts an example of a hospital computing device according to some implementations.

FIG. 15 depicts an example of a health repository computing device according to some implementations.

FIG. 16 depicts an example of a client computing device according to some implementations.

### DETAILED DESCRIPTION

### Accessing Information in a Database

The technologies described herein are generally directed towards providing access to information maintained in a database. For example, a user is able to use a connection component to provide identification information that positively and uniquely identifies either the user or another person, such as for accessing, viewing and/or receiving information in the database corresponding to the identified person. The connection component may apply a matching process that compares the identification information provided by the user with known identity information for the person being identified, such as may be obtained from the database.

Additionally, following the matching of the person with the person's identity information, some implementations herein provide for linking of an external account of the user with the information contained in the database. For instance, the user's external account may be linked through an account created at the connection component by the user, thereby linking the external account of the user to the information contained in the database. Following linking, the user may then access the corresponding information through the connection component account. Further, as a result of the linking, there is a flow of information corresponding to the established identity between the database and the external account.

As an example, some implementations provide a connection component through which, following an identity matching process, a patient is able to access patient information maintained by a hospital, clinic, outpatient facility, physician's office, or the like (hereafter “hospital”). Consequently, following patient matching, the patient may be able to actively manage his or her hospital visit records, preregistrations, connections to personal care providers (e.g., primary care physician, referring physician, nursing home staff, etc.) and other patient information in the hospital database from within or outside of the hospital infrastructure.

In some implementations, a patient may have a health repository account in an online health repository that is external with respect to the hospital infrastructure and the hospital database. By creating an account with the connection component and carrying out a matching and linking process, as disclosed herein, the patient is able to link patient records in the hospital database to the health repository account through the account created using the connection component. This linking of records and accounts enables a flow of information between the patient information contained in the hospital database and the health repository account. Consequently, a patient can receive the patient information in the hospital database through the patient's health repository account at the health repository. Further, the patient is able to view and determine the status of certain patient information through the connection component account. Thus, some implementations herein provide patients access to patient information contained in a hospital database through a secure connection component for enabling the patients to access their patient information maintained by a hospital. In addition, the patient may also provide preregistration information obtained from the health repository account to the hospital through the connection component.

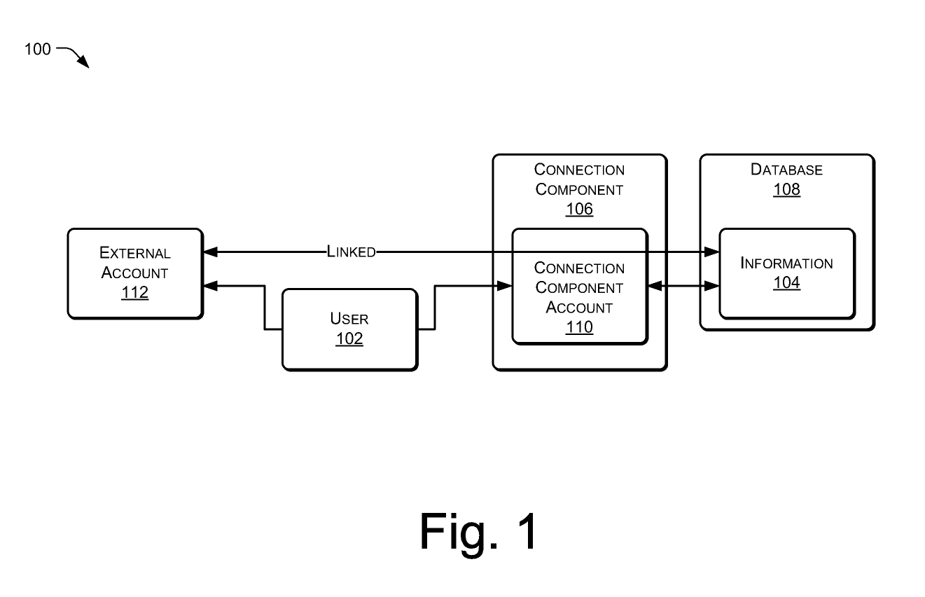

FIG. 1 illustrates an example for discussion purposes of a framework 100 to provide a user 102 with electronic access to user information 104. In the illustrated example, framework 100 includes a connection component 106, which may be an application or other component able to electronically communicate with both the user 102 and a database 108, which may be a database securely storing information 104 of either the user or another person. Connection component 106 is configured to interact with the user 102 and the secure database 108 for providing the user 102 with access to the information 104. In some implementations, the connection component 106 may present a website or other user interface to the user for facilitating the user access to the information 104. For example, as described additionally below, the user 102 may create and use a connection component account 110 to securely match an identity of the user or another person with an identity corresponding to the information 104 maintained in the database 108 to enable the user 102 to electronically access the information 104.

Furthermore, responsive to the matching of identification information provided by the user to the identity corresponding to the information 104 in the database 108, an external account 112 of the user may be linked with the information 104 contained in the database 108. For example, external account 112 may be an account that is external to the database 108 and controlled by the user, such as a personal account in an online service or database, which may be provided through a web interface, website or the like. In some implementations, the user's connection component account 110 may use the same login identifier and password as the external account 112 of the user, and both accounts 110, 112 may be created during a single sign up procedure, or during separate sign ups. The matching and linking carried out using the connection component account 110 provides for linking between the information 104, the connection component account 110 and the external account 112 to enable movement of information 104 between the database 108, the connection component account 110 and the external account 112. For example, following the linking, information 104 may be automatically transferred from database 108 to external account 112. Further, information 104 can be accessed and viewed by the user through connection component account 110. Consequently, implementations herein provide a framework 100 by which a user is able to securely electronically access and receive the information 104 in the database 108.

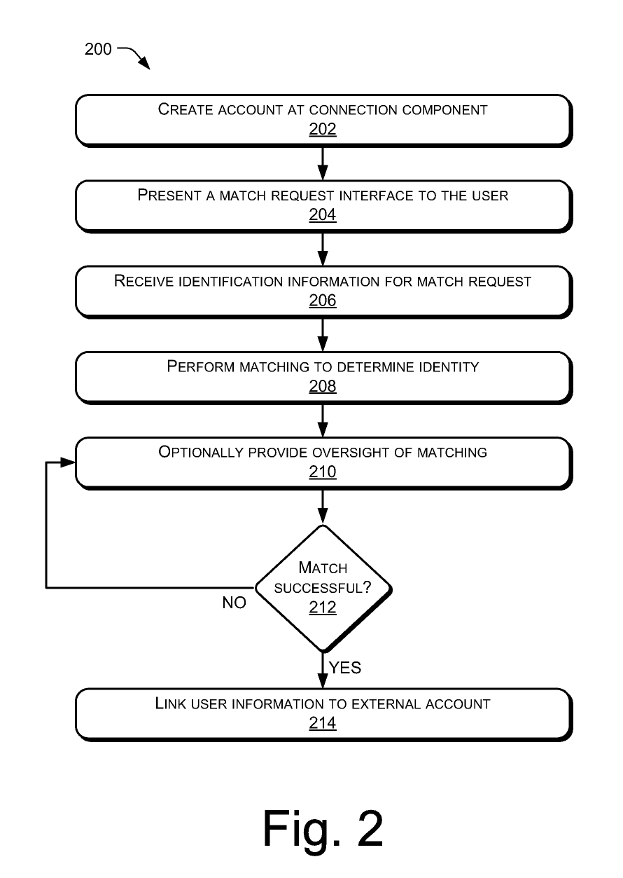

FIG. 2 depicts a flow diagram of an example process 200 for electronically accessing information according to some implementations herein. In the flow diagram, the operations are summarized in individual blocks. The operations may be performed in hardware, or as processor-executable instructions (software or firmware) that may be executed by one or more processors. Further, the process 200 may, but need not necessarily, be implemented using the framework of FIG. 1. Consequently, by way of explanation, and not limitation, the process 200 is described in the context of the framework of FIG. 1.

At block 202, in response to actions by a user, the connection component creates an account for the user. For example, the user may access the connection component over the Internet (e.g., the World Wide Web) for creating an account. Furthermore, in some implementations, the connection component account created on the connection component may map at least in part to an external account of the user, such as in an online database, web service, website, or the like, as is described additionally below. In some implementations, the user may sign up for the external account during the process of signing up for the account on the connection component, such as by being redirected from the connection component to the online database website, and then being redirected back to the connection component following creation of the external account.

At block 204, the connection component may present a match request interface to the user. The match request interface requests that the user provide identification information in order to match the identity of the user or another person with an identity corresponding to the information contained in the secure database.

At block 206, the connection component receives the user identification information submitted by the user in the match request interface. For example, in response to presentation of the match request interface, the user may provide specified identification information to enable the connection component to securely match the identity of user or the other person with the identity corresponding to the information contained in the secure database.

At block 208, the connection component performs matching by comparing the identification information received from the user with the identity corresponding to the information in the database.

At block 210, optionally, in some implementations, database operators or staff may provide oversight and management of the matching process. For example, a match request may include identification information submitted by a user, which is received and used by the staff to achieve a match with an identity corresponding to the information contained in the database.

At block 212, a determination is made as to whether the match was successful. For example, matching may be carried out automatically or in conjunction with staff management. When matching is carried out automatically, in some implementations, an exact, unique match between the information supplied by the user and the information in the secure database may be specified. According to these implementations, when an exact, unique match is not achieved, staff oversight may then be requested by the connection component, or in other implementations staff oversight might always be requested. Additionally, in other implementations, an exact unique match may not be required. Further, in some implementations, the matching criteria may be dynamically filtered by the staff for obtaining a match. The staff can use the filter to adjust displayed matching criteria when comparing identification information received from a user with identity information already maintained in the database when attempting to determine a match. Additionally, some implementations enable the database provider to easily change the identity criteria used for the matching. This feature enables the database provider to customize the identification information requested from users of the system, such as for adjusting security requirements, enabling use of special account numbers as identifiers, or the like.

At block 214, as a result of the successful matching, the external account and connection component account of the user or the person matched may be linked through the connection component to the corresponding information contained in the database. Following, linking of the external account to the connection component account, implementations enable the corresponding information to be moved between the database and the external account in the online service or database. In addition, the user may also access or view the corresponding information in the database through the connection component account.

Consequently, the above framework 100 and process 200 can be used for providing a user with electronic access to the information in a database. Furthermore, while some examples provided herein are given in the context of a patient accessing patient information in a hospital database, those of skill in the art will recognize that implementations herein are not limited to the specific examples, and that the implementations disclosed herein are applicable to numerous other environments in which it is desirable for a user to be able to access or receive information maintained in a database.

### Connection Component Examples

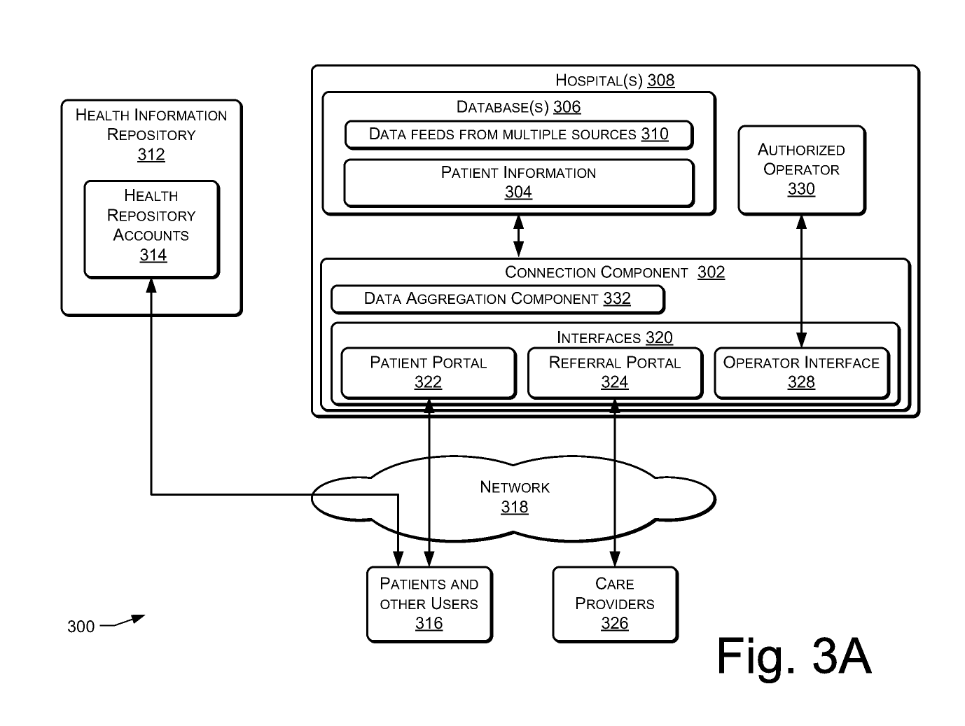

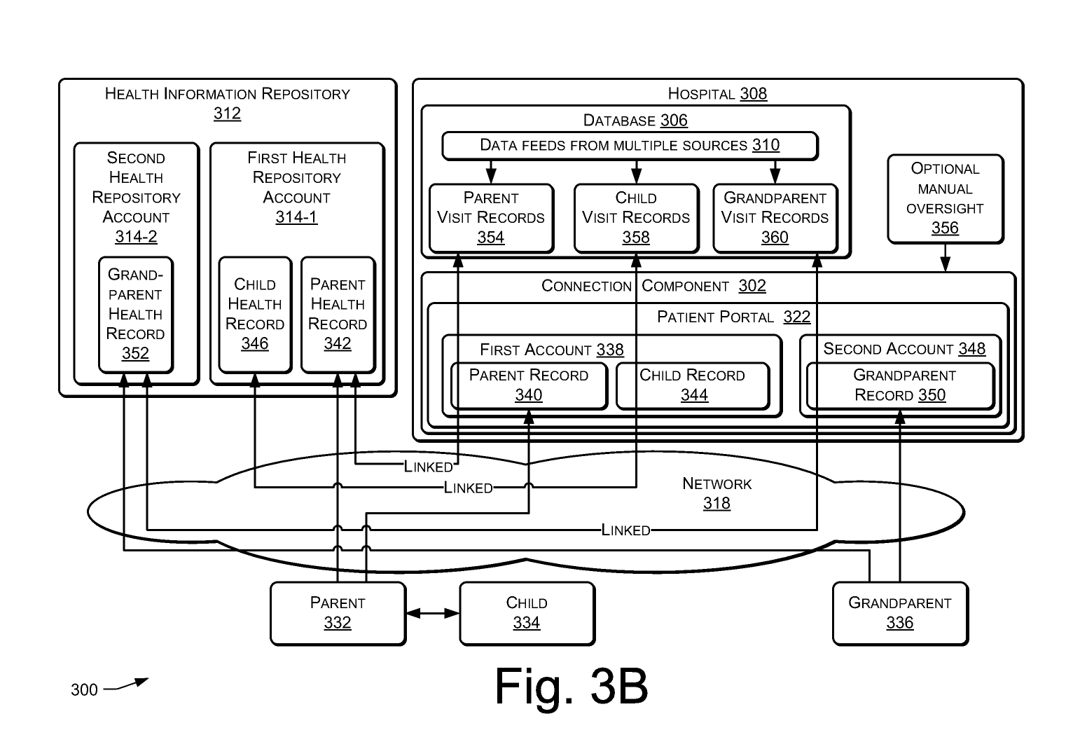

FIG. 3A illustrates an example of a system 300 for accessing patient information, such as hospital visit information, or the like, according to some implementations herein. The system 300 includes a connection component 302 for enabling electronic access to patient information 304 in one or more hospital data stores or databases 306 of one or more hospitals 308. According to some implementations, the hospital data store or database 306 (hereafter “database 306”) may be a unified data aggregation platform able to receive data feeds 310 from multiple sources such as a plurality separate applications and databases in the hospital, such as in different departments, etc. An example of such a healthcare data aggregation platform is Microsoft® Amalga™ Unified Intelligence System available from Microsoft Corporation of Redmond, Wash. Thus, the hospital database 306 may be a suitable platform or database able to tap into and receive existing data feeds from other applications, databases and departments throughout the hospital for gathering and merging the available information on the particular patient to create a unified record of the patient's visit. For example, the patient information 304 may be hospital visit information that may include information or reports obtained from patient registration, operation or surgery information, radiology information, prescription and pharmaceutical information, therapeutic treatment information, doctor and nursing notes, and the like, gathered from a variety of different sources and storage locations throughout the hospital. Consequently, in some implementations, data feeds 310 from multiple sources can be automatically gathered or received by database 306 and added to patient information 304.

Additionally, in other implementations, the hospital database 306 may be a different type of database that contains patient hospital visit information that is manually assembled or generated using other types of technology. For example, in these implementations, patient hospital visit records may be manually generated and entered into hospital database 306. Further, the hospital database 306 may be located at the hospital 308, or may be located at a remote location relative to the hospital 308. For example, the database 306 may be hosted at a data center accessible over the Internet or though other suitable communication link. Consequently, implementations herein are not limited to a particular hospital database type.

System 300 also may include a health information repository 312 that is external to the hospital database 306 and any hospital infrastructure. According to some implementations, the health information repository 312 may be a website, web server, or the like. The health information repository 312 may provide an online database or platform that allows individuals to store and personally manage in a central location personal health and fitness information obtained from a number of different sources. An example of a suitable platform is Microsoft® HealthVault™ available from Microsoft Corporation of Redmond, Wash., although other suitable online databases and repositories may also be used. In some implementations, health information repository 312 may allow access to an individual's health record through a health repository account 314. Thus, health repository account 314 may be used to store health and fitness information that is accessible by patients and other users 316 over a network 318, such as the Internet or other suitable communication network. Other users might include individuals authorized to act for the patient, or the like. Further, a single health repository account 314 may be used to manage and access health records for a plurality of individuals, such as the members of a family, e.g., parent health records and the health records of the parents' children. As one possible example, an individual may be able to access his or her own health record and also the health record of a child, spouse, parent or the like contained in the same account.

Additionally, it is also possible for a first health repository account to grant a second health repository account full or partial access to one or more health records in the first account. For instance a user might have complete read and write access to all the health records in their health repository account, such as the health records of their spouse or child. Also, another individual, such as a grandparent having a second account, might be granted read and write or read-only access to one or more of the health records in the first account through the second account. Thus, the health records in the health information repository 312 may be configured to be accessed in whole or in part by one or more authorized or registered individuals using one or more accounts.

Connection component 302 may include interfaces 320 for enabling access and interaction with the connection component 302. For example, connection component 302 may include a patient portal 322 that can be used by patients and other users 316 to access connection component 302, such as for creating an account to view patient information 304 and for linking patient information 304 to a health repository account 314. In some implementations, patient portal 322 may be a website, web service, or the like, accessible over network 318, such as through the World Wide Web.

Connection component 302 may further include a referral portal 324 that can be used by care providers for accessing patient information 304. For example, care providers 326, such as personal physicians, referring physicians, clinics outside the hospital, nursing homes, and other types of care providers external to the hospital can be authorized through the referral portal 324 to access patient information 304 for a particular patient. This authorization may be the result of a request made by a patient or other user 316, or a request made by a care provider 326, and is subject to review and approval by the hospital staff. In some implementations, referral portal 324 may be a website, web service, or the like, accessible over network 318, such as through the World Wide Web. For example, when a care provider wishes to access visit records for a particular patient, the care provider may provide identification information about the particular patient similar to the patient matching that may be carried out by a patient for accessing information of an identified patient.

Connection component 302 may further include an operator interface 328 for use by authorized operators 330 of the connection component, such as hospital staff, system administrators, or the like. For example, hospital staff may oversee or control a number of operations of the connection component as described additionally below, such as overseeing patient matching and linking, reviewing requests from patients or care providers to provide access by care providers to patient information, and the like.

Connection component 302 may further include a data aggregation component 332 that aggregates and monitors patient information 304. For example, data aggregation component may determine whether patient information 304 for a particular patient has been updated, and provide the patient with an indication of the update when the patient accesses the patient portal. Further, aggregation component 332 may perform numerous other functions, such as creating metadata for monitoring patient information 304, monitoring patient access to the patient information, and the like.

FIG. 3B sets forth an additional example for explanation purposes of the system 300 described above. In this example, a parent 332 has a child 334 and a parent, i.e., grandparent 336. The parent, child and grandparent are examples of possible patients and/or users of the system, but implementations herein are not limited by this example.

In the system 300 of FIG. 3B, a parent 332 is able to access patient portal 322 of connection component 302 through network 318. According to some implementations, when parent 332 first connects with the connection component 302, parent 332 may use the patient portal 322 to create a first account 338. In some implementations, the first account 338 may map to a first health repository account 314-1 of the parent 332. For example, parent 332 may already have the first health repository account 314-1 before signing up for the first account 338 at the connection component 302. In other implementations, as the parent 332 is signing up for the first account 338, the parent may be redirected to the health information repository 312 to also sign up for the first health repository account 314-1. In other implementations, the parent may sign up for the first health repository account 314-1 after signing up for the first account 338 at the connection component. Also, according to some implementations, the parent uses the same credentials, such as the same login ID and password, for both the first account 338 on the connection component and the first health repository account 314-1. This enables a user to be redirected from an account at the connection component to a corresponding account at the health repository, and vice versa, without requiring additional login.

Further, one or more records in the first health repository account 314-1 may map to the first account at the connection component 302. Thus, a parent record 340 may be created at the connection component 302 that corresponds with a parent health record 342 at the first health repository account 314-1, and a child record 344 may be created at the connection component 302 that maps a child health record 346 at the first health repository account 314-1. Thus, all or a subset of the records in the first health repository account 314-1 may be mapped to the first account 338 at the connection component 302.

In addition, grandparent 336 may also access patient portal 322 for creating a second account 348 that corresponds to a second health repository account 314-2, such as in the manner described above. A grandparent record 350 in the second account 348 may correspond to a grandparent record 352 in the second health repository account 314-2.

Before permitting parent 332 to access patient information, such as parent visit records 354 in the database 306, the connection component 302 may require the parent 332 to provide information for positively matching and linking the parent to the parent visit records 354. Thus, the connection component 302 may present an interface to the parent 332 that requests identification information from parent 332 in order to match parent 332 with identity information corresponding to parent visit records 354 maintained in the hospital database 306. Thus, the identification information obtained from parent 332 by the connection component 302 may be used to perform matching and linking for securely matching an identity of parent 332. Further, when the identity of parent 332 has been positively matched using first account 338, the hospital visit records 354 of parent 332 can be linked with the parent health record 342 at the health information repository 312 and the parent record 340 in the first account 338 provided by the connection component.

During the matching, parent 332 may be asked to provide a variety of identification information for verifying the identity of parent 332. In some implementations, hospital 308 may provide optional manual oversight 356 during the matching and linking in which hospital staff verify and ensure that the person seeking access to the parent visit records 354 is in fact the correct person. After parent 332 has been matched to the parent record 340, the parent record 340 in first account 338 is linked to the parent visit records 354 so that parent 332 is able to access the parent visit records 354 through first account 338. Furthermore, following linking, parent's health record 342 in the first health repository account 314-1 is linked to parent visit records 354, so that parent visit records 354 may be automatically transferred to parent health record 342 at health information repository 312.

In addition, parent 332 is able to provide identification information for child 334 to the connection component 302 for matching an identity of the child 334 to identity information maintained in the hospital database corresponding to child visit records 358, and for linking the child visit records 358 to child health record 346 in the first health repository account 314-1. Consequently, this action results in the child visit records 358 being assessable to parent 332 through the first account 338 and also available for delivery to and accessed through the child health record 346 in the first health repository account 314-1.

Furthermore, following the matching and linking of the parent's identification information, the parent 332 may submit a request specifying one or more care providers to access the parent visit records 354. Similarly, following matching and linking of the child's identification information, parent 332 may submit a request to authorize one or more care providers 326 to access the child visit records 358. The component authorized operator 330 can review these requests using the operator interface 328 for deciding whether to approve the requests. For example, in some cases, the hospital staff may deny this access request for various reasons, such as a particular care provider 326 not being registered with hospital 308, or the like.

Additionally, it should be noted that read and write privileges might be required for executing matching and linking, and thereby for requesting access for a care provider to a particular record. For example, since the grandparent has read-only access to the child health record 346, the grandparent is unable to perform matching and linking for the child health record 346 to the child visit records 358. Further, since the grandparent has read-only access, the grandparent cannot specify care providers to access the child visit records 358. Consequently, according to some implementations, a user that has read-only access to a particular record is not able to perform matching and linking for that record or authorize a care provider to have access to that record. On the other hand, if the grandparent has both read and write access, the grandparent is able to specify care providers that can access the child visit records 358 and the grandparent could also carry out matching and linking if matching and linking had not already been performed by the parent.

Implementations herein provide a connection component 302, which may also correspond to the connection component 106 described above, that is a multi-record application for hospitals to provide to their patients so that patients can perform a number of different activities. For instance, the connection component 302 may be configured to provide access to a patient's hospital visit information that is gathered and aggregated from a number of different hospital information-technology systems and make this information available to the patient and the patient's care providers. The connection component 302 also may enable the patient to view, store and/or share information for each hospital visit from any computing device with Internet access or other access to the connection component 302. For example, hospital visit records can include dates of admittance and discharge, a discharge summary write-up, lab results, prescriptions and pharmaceutical information, and the like. Additionally, the connection component 302 may enable patients to pre-register for hospital visits online using electronic personal health information stored in the patient's health repository account 314, which speeds up the preregistration process while also helping to ensure consistency of information provided by the patient over time.

Accordingly, the connection component 302 can enable patients to connect or link their health repository accounts and connection component accounts to patient records inside the hospital, and stored in the database 306 through patient matching and linking. Through this linking, a patient may use the patient's health repository account to receive patient records from the hospital database. Further, through linking of the connection component account, the patient can access and view the patient records, manage access by care providers, and the like. Consequently, following a secure verification process, implementations provide a front-end user interface 320 that can access the back end hospital database for providing direct access to patient hospital visit information. Additionally, while some implementations herein are described in the context of the system of FIGS. 3A-3B for explanation purposes, the implementations herein are not limited to the particular configuration of the system 300, but extend to additional system implementations and configurations.

### Matching and Linking

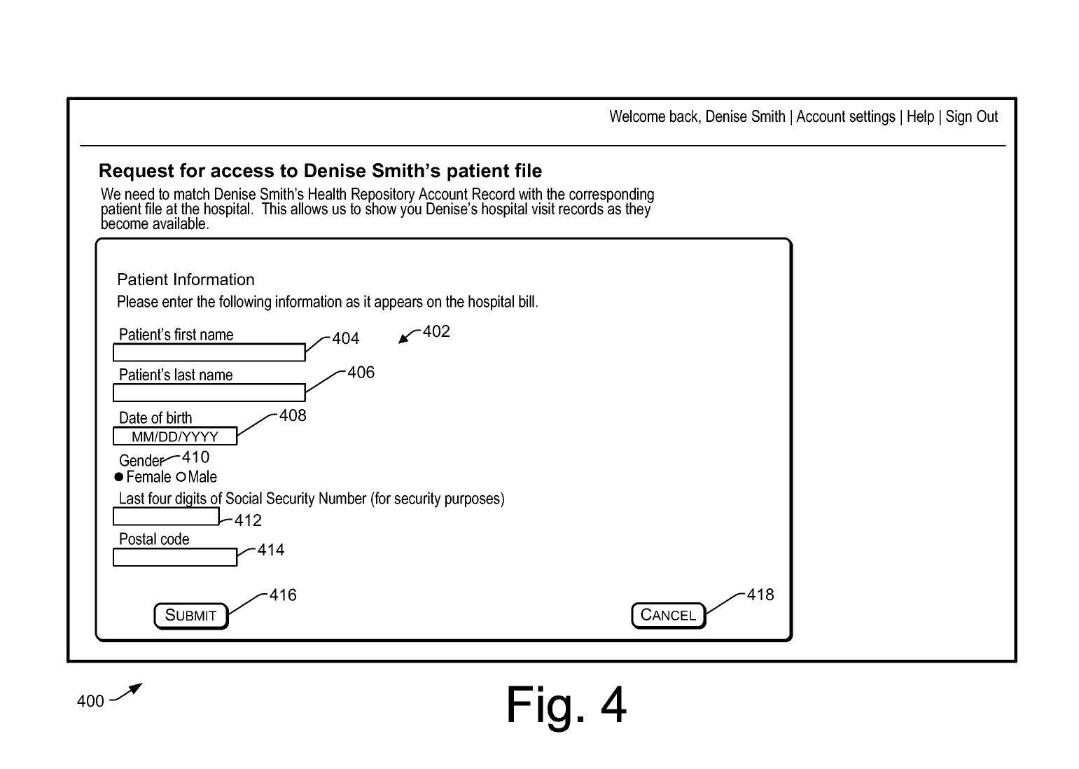

FIG. 4 illustrates an example of a match request identification information interface 400 that may be completed by a user for executing a patient match request. For example, identification information may be entered by the patient for himself or herself, or the identification information may be entered by a user able to act on behalf of the patient, such as a parent. The identification information interface 400 may be generated by the connection component patient portal 322 for presentation to a user for obtaining patient identification information to use during matching of the patient identity. Identification information interface 400 provides a plurality of information entry fields 402 for obtaining specific identification information regarding the patient. In the illustrated example, requested information includes the patient's first name 404, the patient's last name 406, date of birth 408, patient gender 410, the last four digits of the patient's social security number 412, and the patient's zip or postal code 414. Further, as described additionally below, the patient information requested can be changed and customized by the hospital staff or other authorized operator, to request different or additional information, as desired by the hospital for their own security purposes, or to match specific information the hospital may have for their patients in their database, such as a billing reference number assigned to each patient. When the user has completed entry of the requested patient identification information, the user may submit the identification information using the submit button 416; or alternatively, if the user desires to cancel the transaction, the user may select the cancel button 418.

Upon selection of the submit button 416, a matching and comparison process is carried out either with or without the oversight of hospital staff or other authorized operator of the connection component 302. Thus, according to some implementations, the matching process may be executed by the connection component without requiring oversight of the hospital staff. However, in other implementations, the hospital staff may be involved in the approval of the patient identity match, either as a standard part of every match approval process, or only when a match is not made during one or more automated match attempts.

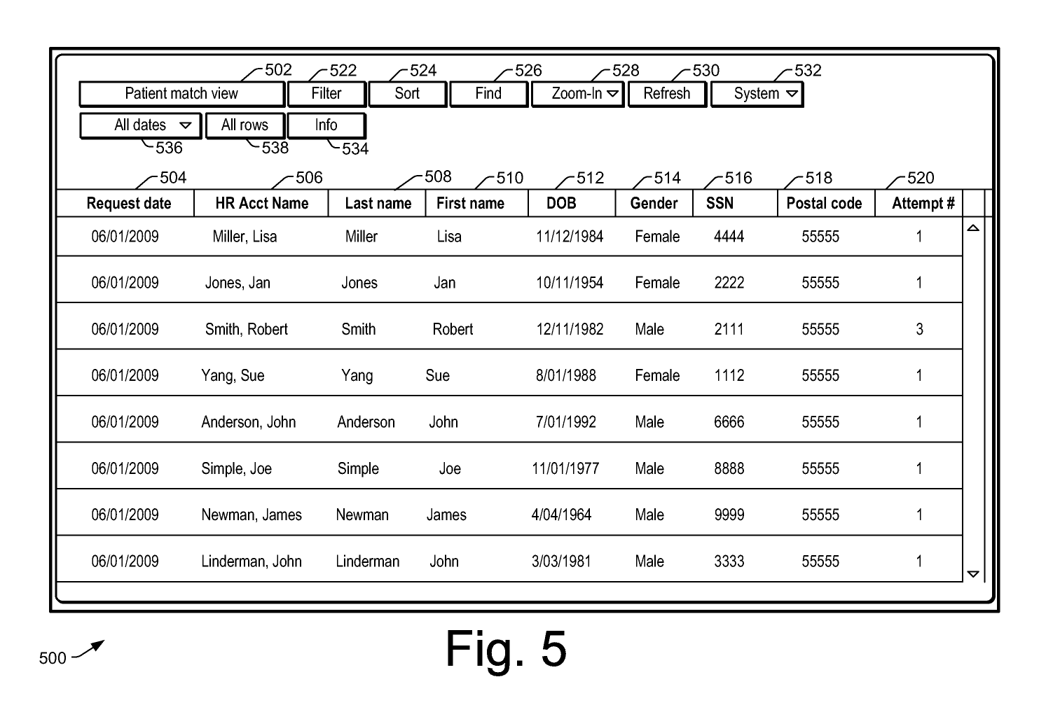

FIG. 5 illustrates an example of a patient match queue interface 500 that may be displayed to the hospital staff or other portal operator by the connection component 302, such as when a user submits patient identification information for carrying out the patient match. Thus, the connection component 302 provides the hospital staff using the operator interface 328 with a selectable patient match view tab 502 that enables listing of match attempts received from one or more users. Clicking on the patent match view tab 502 enables the staff to switch to a queue for care provider requests waiting for approval, or other views/queues. In the illustrated example, the information for each match request includes a request date 504 and a health repository account (HR Acct) name 506. As mentioned above, the health repository account may use the same login credentials, i.e., username and password, as the connection component account.

The listed information further includes information that corresponds to the information submitted using the patient identification information interface 400, i.e., patient last name 508, patient first name 510, date of birth 512, gender 514, last four digits of Social Security number 516, and zip or postal code 518. Also, the listed information may include the number of match attempts 520 submitted for this patient so far. For example, a large number of attempts 520 may indicate an attempt to hack into the patient information, or may indicate a patient that needs additional assistance in supplying the specified information.

In addition, a number of selectable buttons may be displayed for enabling the staff member to perform different actions or switch to different views. For example, such buttons may include a filter button 522, a sort button 524, a find button 526, a zoom-in button 528, a refresh button 530, a system button 532 and an info button 534. By selecting one or more of these buttons, a staff member may perform actions such as filtering or sorting of the listed patients, locate a particular patient request, view details of a request, and so forth. Further, an all dates drop-down menu enables filtering according to different dates or date combinations, and in all rows button enables filtering a number of rows displayed.

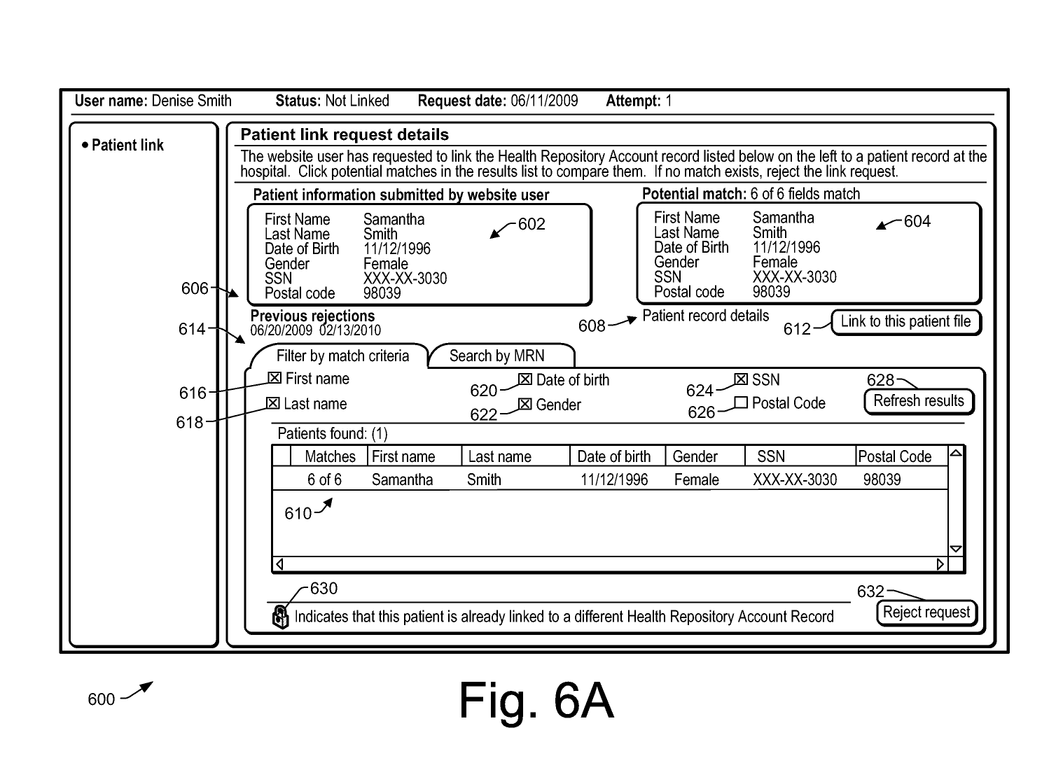

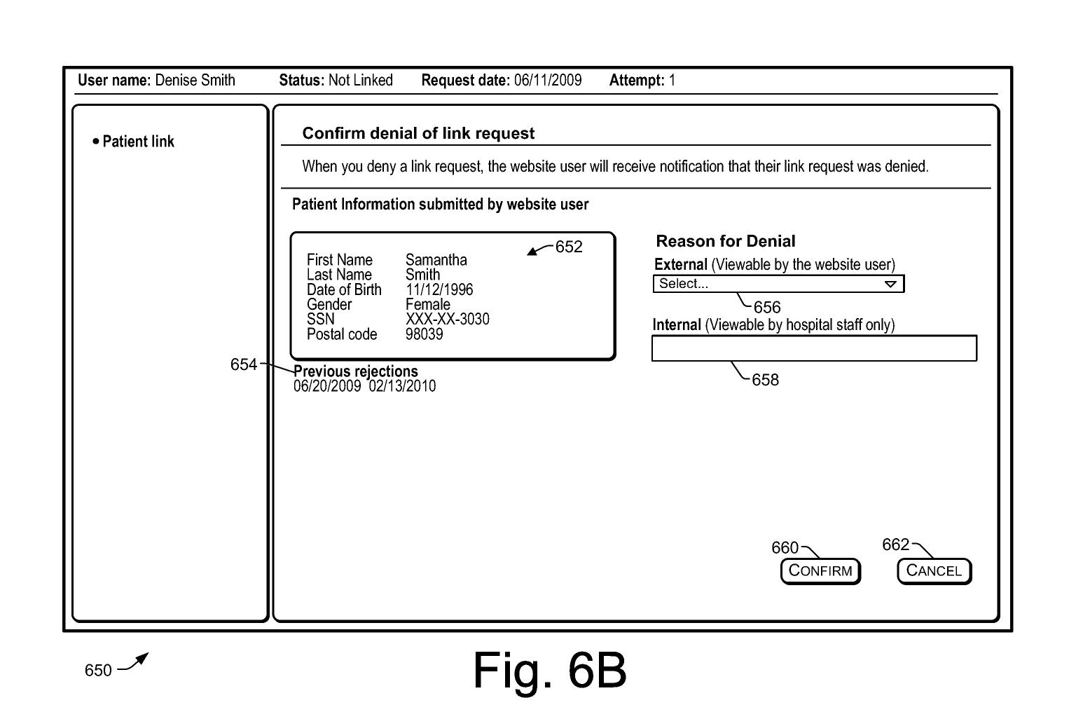

FIG. 6A illustrates an example of a patient matching interface 600 that can be displayed to hospital staff or other authorized operator in response to receiving a match request attempt for a patient. As will be discussed additionally below, the patient matching interface 600 may be displayed to a hospital staff member as a result of several different circumstances. For example, in some implementations, matching may be an automated process that is carried out by the connection component 302 without staff intervention if a unique, exact match is found for the patient. Thus, if all the information submitted for the patient in the patient identification information interface 400 matches the information contained in the hospital database, and only matches a single record, then the patient linking may be automatically executed by the connection component. On the other hand, in some implementations a hospital may desire that every patient match request is reviewed and approved by a hospital staff member. Furthermore, some implementations may be a combination of the two implementations mentioned above, in which a patient may make one or more attempts at automatic matching and linking which, if unsuccessful, may then be submitted to a hospital staff member for further action.

The patient matching interface 600 may include a side-by-side display for enabling a comparison of the patient identification information 602 submitted for the patient through the connection component account and the patient identity information 604 obtained from the hospital database. The information 602 displayed may correspond to the identification information requested for the patient in the patient identification information interface 400 discussed above. To improve match recognition for the hospital staff, identification information fields that match may be colored the same color for information 602, 604, while fields that do not match may be colored different colors from the corresponding other information fields and from the matching fields.

The patient matching interface 600 may further include a previous match request link 606 that becomes available when a possible match has been selected. The previous match request link 606 may be selected to view previous rejections of matching requests for this patient. Also, a record details link 608 may provide access to patient record details, such as what types of patient records the database may contain and the like. For example, selection of the record details link 608 can produce a pop-up window that displays a full set of data for the patient records in the hospital database so that the staff has more information to determine whether there is a match.

Additionally, patients found list 610 provides a listing of matching patients found showing the number of matches in the requested matching criteria for each listed patient. In this example, a single patient record has been located showing six out of six matches for the matching criteria, i.e., first name, last name, date of birth, gender, social security number, and zip or postal code. Accordingly, if the patient-submitted information 602 exactly matches the patient identity information 604 from the database, the staff member may select the linking button 612 to link the patient to the patient records in the hospital database. Selection of the linking button 612 can complete the matching of the patient and also can link the patient records in the hospital database to the patient's health repository account, so that the patient is able to access the hospital records in the hospital database through the patient's health repository account.

Furthermore, in some implementations, if an exact match is not made, then the staff is unable to confirm the match. Thus, in the case in which an exact match is not made, the hospital staff may have the option to filter the results according to match criteria using a filter 614. For example, the filter 614 may have selectable fields or boxes corresponding to each of the match criteria set forth in the patient identification information interface 400. Consequently, in this example, the filter 614 has selectable fields or boxes for first name 616, last name 618, date of birth 620, gender 622, social security number 624, and postal code 626. The staff member may unselect one or more of the boxes and then activate a refresh button 628. This may result in a reordering of any patient matches listed in the patient found list 610 or may result in the display of additional possible matches. By clicking on one of the listed patients, the patient identity information 604 for that patient is displayed as a potential match which the staff can then compare with the patient information 602 submitted by the user. Thus the filter 614 enables the staff to more easily locate potential matches. Further, in some implementations, the filter may only list patients who are 100% matches to the currently selected criteria to limit staff ability to remove matching criteria and reduce the chance of making a bad link

In addition, in some implementations, an attempt may be made to complete a match and link for a patient when the patient is already linked to their records through a different health repository account record. This condition may be indicated to the staff member in the match list 610 by an already matched indicator 630. According to these implementations, the staff member may be prevented from activating the link 612 to link the hospital patient record to a second health repository account record, as it is desirable for the hospital patient records to be linked to a single external patient record. Thus, according to some implementations, each patient record in the hospital database can only be matched to a single patient health repository account. Furthermore, when a match is not found, or when the staff determines that the patient information submitted on the match request is not the patient identified in the hospital database, the staff member can select a reject request button 632 to reject the match request. The rejection message may then be sent to the user attempting the match.

FIG. 6B illustrates an example of a denial of link request confirmation interface 650 of the connection component user interface for use by the hospital staff when confirming a denial of a request for matching and linking. For example, the patient information 652 that was submitted by a user may be displayed along with any previous rejections 654. Furthermore there may be a selectable drop-down menu 656 to enable the staff member to select a reason for the denial that will be delivered in a message to the user. Additionally, there may be a text entry field 658 in which the hospital staff may type notes that provide additional reasons for the denial for internal hospital use. The staff member may then either select the confirm button 660 to confirm the denial or a cancel button 662 to cancel the denial.

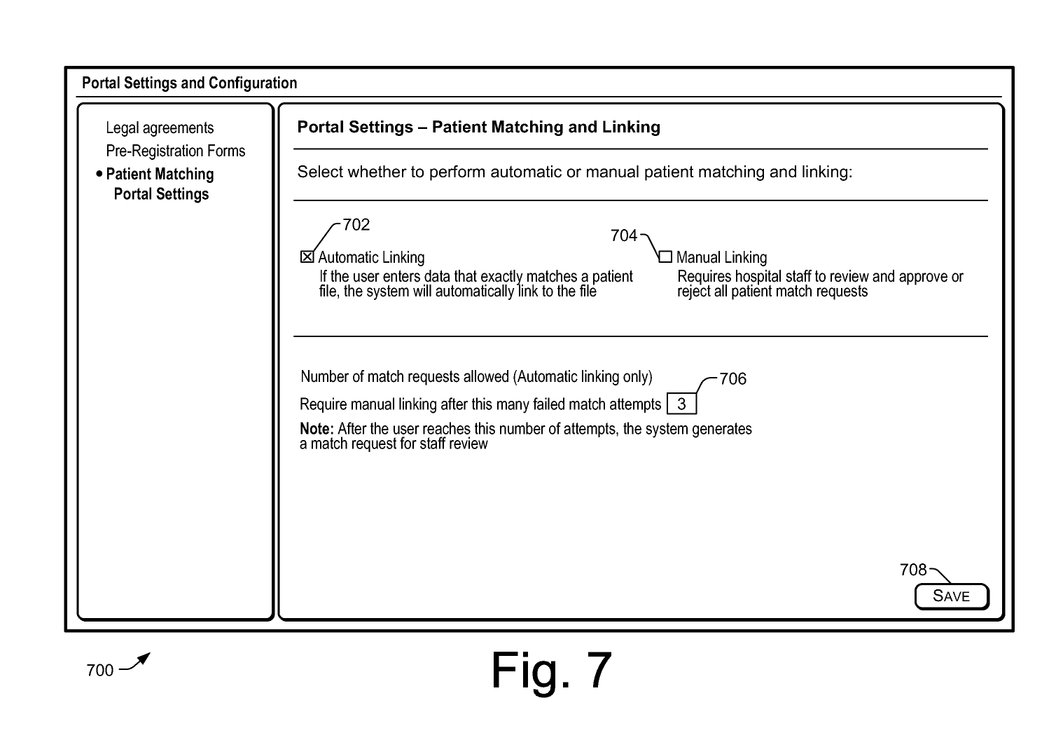

FIG. 7 illustrates a manual or automatic linking setting selection interface 700 of the connection component user interface that displays selectable fields that may be used by the hospital staff or other authorized operator for specifying whether the matching and linking will be carried out automatically or under hospital staff supervision. For example, the hospital staff may select an automatic linking selection field 702 or the manual linking selection field 704 to complete this setting. Furthermore, when automatic linking selection field 702 is selected the hospital staff may select the number of match request that are able to be submitted for automatic matching before the next attempted match is switched over to manual linking to obtain staff supervision. For example, box 706 receives a number that specifies the number of automated match request attempts that may be made. Thus in the illustrated example after three unsuccessful attempts at automatic matching and linking, the next time the user submits a match attempt, the match attempt is automatically submitted to the hospital staff for manual matching and linking oversight and confirmation. When the desired manual or automatic patient portal configuration selections have been made, a save button 708 may be activated to save the selections.

### Control of Multiple Records Through Single Account

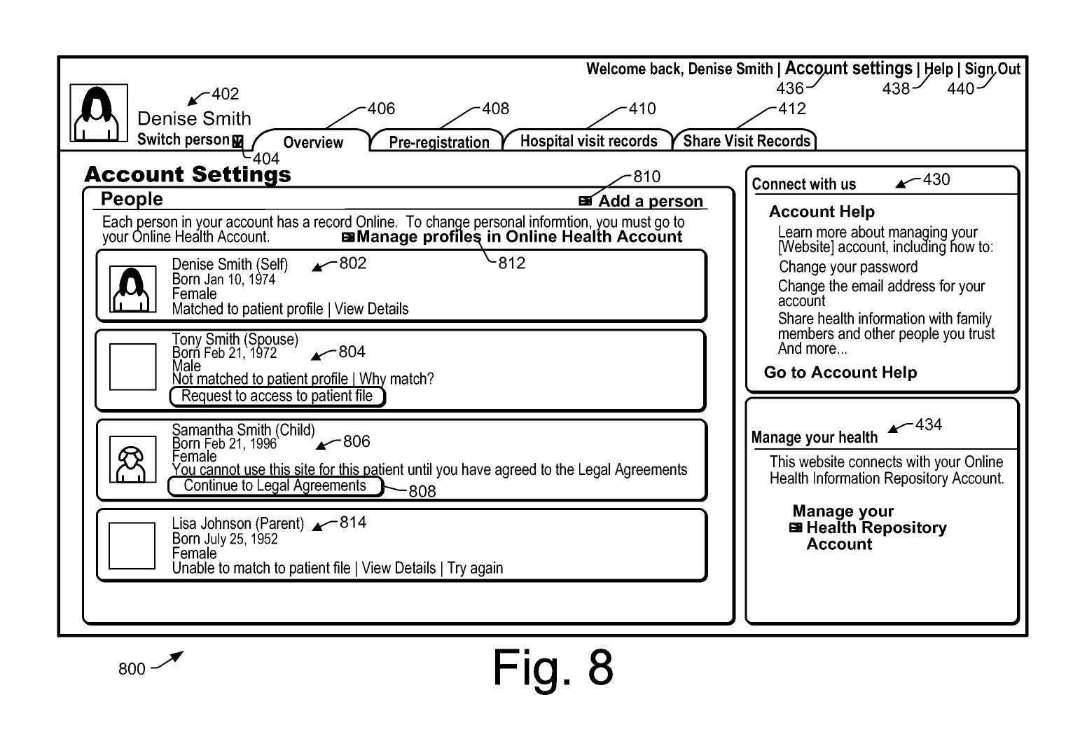

FIG. 8 illustrates an account settings and record selection page 800 of the connection component user interface that may be presented by the patient portal 322 in response to the patient selecting the account settings link 436. As mentioned previously, the connection component permits multiple records for different patients to be managed in the same connection component account. Thus, a patient that is matched and linked in the connection component 302 may include multiple records e.g., an entire family, in a single account accessed by a single login credential. Furthermore, a particular connection component account record can be shared between multiple connection component accounts and when a patient's hospital record has been matched and linked to the patient's health repository account record (i.e., creating a link between the record in the health repository account and the patient visit records in the hospital), all individuals with authorized access to that health repository account record are also able to access the patient's hospital visit records based on the sharing privileges set up in the health repository account (e.g., read-only, read-write, etc.). Consequently, according to implementations herein, a user is able to set up a single connection component account for the entire family based on their health repository account, and may then use their health repository account relationships to establish relationships that are honored by the connection component when interacting with the corresponding hospital visit records. Thus, based on sharing relationships established between health repository accounts, there may be a one-to-many relationship between a single connection component record and multiple health repository accounts.

Further, after the patient has performed a patient match once for a particular online health account record, then all health repository accounts that are able to access that health record are also able to access the hospital visit records for that patient through the connection component. Additionally, the connection component can support the online health account's read-only as well as read/write relationships. Consequently, a patient's health record in the health repository account with read-only rights is not able to initiate a patient match request at the connection component, nor can they save information from the connection component back into the health repository account record. However, a read-only health repository account is able to submit a preregistration, view hospital visit records (if a patient match has already been performed by someone with a read-write access account) and initiate patient-provider connection requests (if a patient match has already been performed by someone with a read-write access account).

In the example illustrated in FIG. 8, Denise Smith's record 802 for the patient Denise Smith has been matched and linked to a patient profile in the database 306, as discussed above, by providing matching information. For example, Denise Smith may correspond to the parent 332 discussed above with reference to FIG. 3B. Consequently, Denise Smith's health repository account parent health record 342 in the health information repository 312 has also been linked to her hospital patient visit records 354 in the hospital database 306. Denise Smith's husband, Tony Smith's record 804, is shown as not having yet been matched to a corresponding patient profile in the hospital database. Further, suppose that Denise is in the process of matching her daughter Samantha Smith's record 806 (corresponding to the child 334 and child record 344 of FIG. 3B), and will be able to provide matching information following selection of button 808 and agreement to the legal agreements. Denise may click on the continue to legal agreements button 808 to proceed with the matching and linking of her daughter's record 806 to the patient visit records of her daughter in the hospital database 306, and thereby matching and linking the patient visit records of her daughter to the corresponding child health record 346 in the health information repository 312. When the steps for submitting the match request have been completed, Samantha Smith's record 806 may show a “match and link pending” status until the matching is approved, either through automated matching an linking executed by the connection component, or through manual matching and linking executed using hospital staff oversight.

In addition, a link 810 may be provided to enable the addition of one or more additional people to the connection component account, for example a parent, additional child, or the like. In some implementations, clicking the link 810 may redirect the user to health information repository 312 for adding a new person's record to the health repository account. Also, because relationships in the health repository account may be used to create corresponding relationships in the patient connection component account, a link 812 may be provided for managing the profiles in the health repository account.

Additionally, the account settings and record selection page 800 may also display unsuccessful match attempts. For example, suppose that Denise Smith attempted to submit matching information for her mother, Lisa Johnson (corresponding to the grandparent 336 in FIG. 3B), but Denise Smith does not have write access to Lisa Johnson's grandparent health record 352 in the health information repository 312, or Lisa Johnson may have already matched and linked the grandparent visit record herself, using the second account 348 and grandparent record 350. Because implementations herein do not permit matching and linking of hospital visit records to multiple accounts or records, and do not permit matching and linking by health repository accounts that do not have write access, the match and link attempt was denied. Thus, Lisa Johnson's record shows that the attempt was unable to match the patient to the file. Other instances of unsuccessful match attempts may be similarly displayed, such as when incorrect information is submitted in a match request.

### Customizing Patient Matching

As mentioned above, implementations herein enable the patient information requested from the user by the patient identification information interface 400 to be customized by the hospital staff or authorized operator. Thus, the fields shown to the user may be changed or customized to correspond to the patient identity information contained in the hospital database or to suit the security requirements of a particular hospital.

There may be three options for how to set-up Patient Matching: (1) default fields; (2) supported fields; and (3) custom fields. The default fields are included in connection component 302 by default. These fields may include: Patient's First Name, Patient's Last Name, Date of Birth, Gender, Last 4 digits of Social Security Number, and Zip Code. If these are the only fields the hospital requires for patient matching, then no additional customization work is required. Supported fields can be added to the patient matching identification information interface 400 from a pre-defined set that may be included with connection component 302. An example list may include: Patient's first name, Patient's Middle Name, Patient's Last Name, Date of birth, Ethnicity, Gender, Marital Status, SSN, Street Address, City, State, Postal Code, Home Phone number, Work phone number, Discharge Date, and MRN. Furthermore, custom fields may be added to the patient matching identification information interface 400 that are outside of the pre-defined set of supported fields.

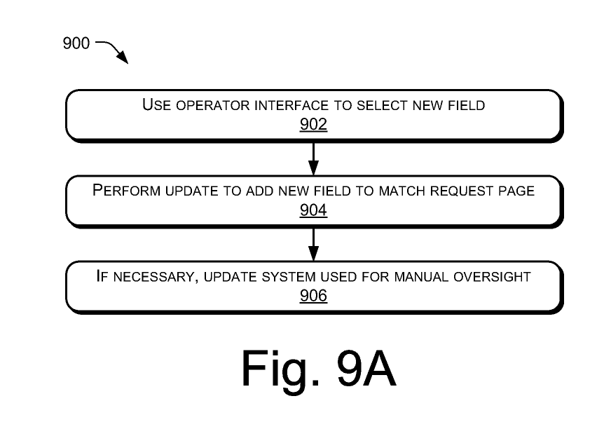

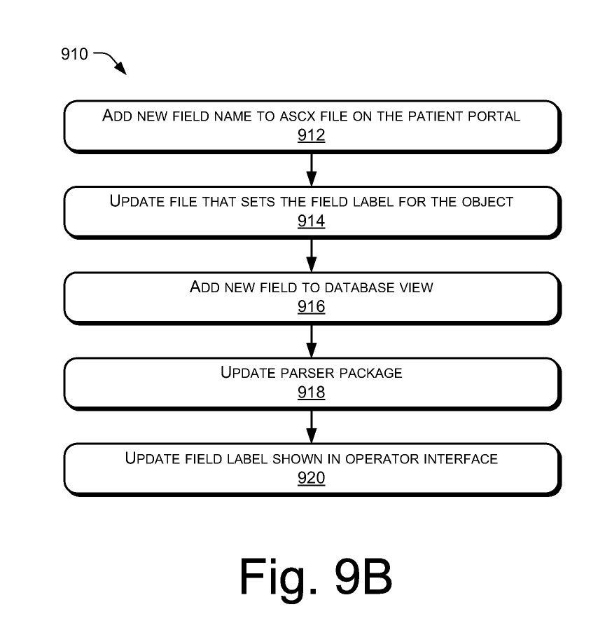

FIG. 9A depicts a block diagram of an example process 900 for customizing supported fields according to some implementations herein. In the block diagram, the operations are summarized in individual blocks. The operations may be performed in hardware, or as processor-executable instructions (software or firmware) that may be executed by one or more processors. Further, the process 900 may, but need not necessarily, be implemented using the examples of FIGS. 4-6. Consequently, by way of explanation, and not limitation, the process 900 is described in the context of the examples of FIGS. 4-6.

At block 902, in order to add a new supported field to the match request identification information interface 400, a staff member may access the operator interface 328 to add the new supported field name.

At block 904, an update is performed to add the new field to the match request identification information interface 400.

At block 906, if necessary, the interface pages used for manual oversight, such as the filter 614, are also updated. For example, according to some implementations, the field labels shown in the operator interface may be read from an XML document created from the patient match request identification information interface 400. If any alterations to the field labels are desired, a content mapping file that controls patient matching fields can be modified. As a result, the patient matching information in the operator interface can handle varying patient match request data coming from the front-end. For instance, if there are five patient match fields on Monday, then five fields are displayed in the identification information interface 400. Thus, when a new field is added on Tuesday, then any match requests submitted on Monday will still show five fields, and any match requests submitted on Tuesday will show six fields. In this way, the fields shown to the staff are dynamically driven by the XML in the patient match request identification information interface 400.

FIG. 9B depicts a block diagram of an example process 910 for adding custom fields according to some implementations herein. In the block diagram, the operations are summarized in individual blocks. The operations may be performed in hardware, or as processor-executable instructions (software or firmware) that may be executed by one or more processors. Further, the process 900 may, but need not necessarily, be implemented using the examples of FIGS. 4-6. Consequently, by way of explanation, and not limitation, the process 910 is described in the context of the examples of FIGS. 4-6.

At block 912, in order to add a new custom field to the identification information interface 400, the new field name is added to a front-end web page file on the operator interface 328 in which text boxes are provided with labels as label objects. Each label object may have its own ID. An example of a new custom field that may be supported is maiden name, which is not in the “supported fields” listed above.

At block 914, a file that sets the field label is updated to set the field label that should be shown for that object ID (e.g., Maiden Name).

At block 916, the new field is added to the database view so the system can access the new data and match against it. At block 918, update the parser package which is customizable to accommodate any new field in patient matching.

At block 920, the field label shown in the operator interface is updated by modifying a content mapping file that controls patient matching field labels.

Further, as mentioned above, the customization of the fields in the patient identification information interface 400 can be automatically incorporated into other parts of the connection component interface. For example, in some implementations, data from the patient match request in the patient identification information interface 400 may be saved in a single column as an XML blob. The operator interface then reads the XML blob to populate the field names and the filter names in the filter 614 discussed above when generating the patient matching interface 600. Thus, any customizations to the patient identification information interface 400 are automatically incorporated into the filter 614 when the patient matching interface 600 is generated. Consequently, the matching process can be customized by the hospital staff using front-end access for the customization.

### Process for Automatic Matching and Linking

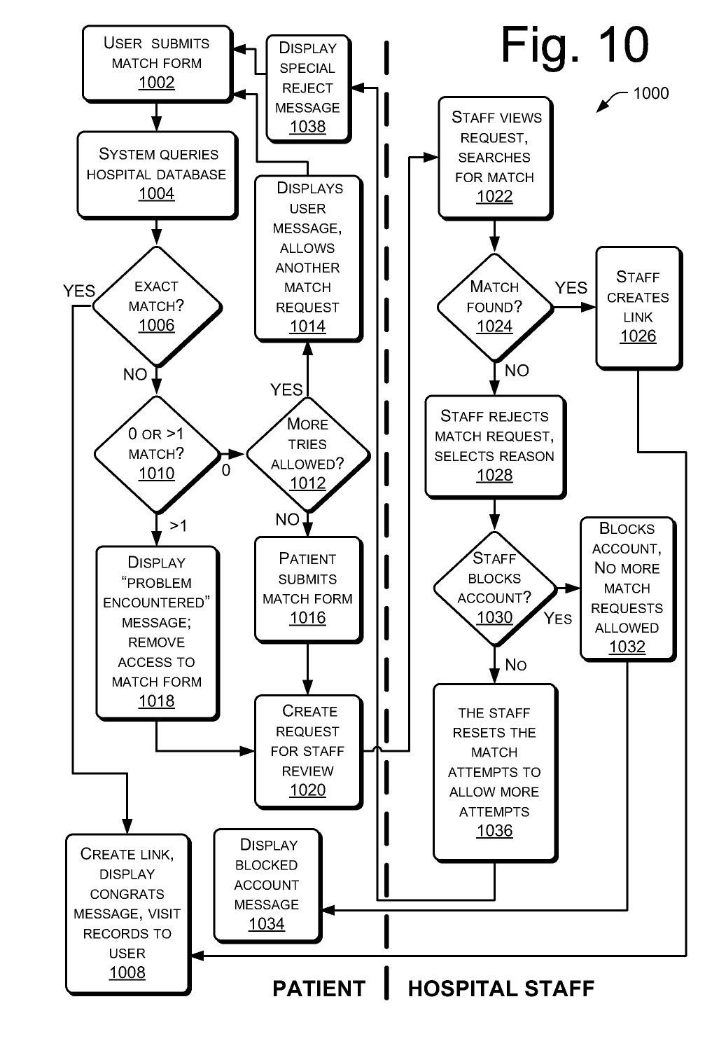

FIG. 10 depicts a block diagram of an example process 1000 for automatic matching according to some implementations herein. In the block diagram, the operations are summarized in individual blocks. The operations may be performed in hardware, or as processor-executable instructions (software or firmware) that may be executed by one or more processors. Further, the process 1000 may, but need not necessarily, be implemented using the examples of FIGS. 3-9. Consequently, by way of explanation, and not limitation, the process 1000 is described in the context of the examples of FIGS. 3-9.

At block 1002, a user submits a completed match identification information interface to the connection component, as described above with reference to FIG. 4.

At block 1004, the patient identification information submitted by the user is compared with the patient identity information contained in the hospital database.

At block 1006, the connection component determines whether or not an exact match is made. An exact match indicates that all of the patient identification information submitted in the match request directly matches the patient identity information contained in the hospital database.

At block 1008, when there is a single exact match during the automatic matching process, the connection component approves the match and may create a link between the patient's connection component account record and the patient's health repository account record, thereby linking the patient's hospital visit records to the patient's health repository account record. The connection component may further display a congratulation message or similar type of notification to the user.

At block 1010, a determination is made as to whether there was no match found or there was more than one exact match found. For example, if more than one exact match is found then it would be undesirable for the connection component to automatically link the patient to one of the matches when the connection component is unsure of which match is the correct match. In this situation, the staff may review the match request to reconcile the discrepancy, as described below.

At block 1012, when no exact match is found a determination is made as to how many attempts the patient has already submitted and whether more attempts are allowed. For example, as mentioned above with respect to FIG. 8, the patient may be limited to a certain number of attempts, such as three, during automatic matching.

At block 1014, when more match attempts are still permitted, the connection component displays a message to the user indicating that the attempt failed and that the user may make another match request. The process then returns to block 1002.

At block 1016, when the patient has submitted the maximum permitted number of match request for automatic matching, the patient is still able to submit another match request, but this match request will be subject to staff oversight.

At block 1018, when there is more than one exact match that corresponds to the match request submitted for the patient, the connection component may display a message to the user indicating that a problem was encountered and may remove the user's access to the match request information identification interface.

At block 1020, a request for staff review is created with respect to either the match request submitted through block 1018 or the match request submitted through block 1016.

At block 1022, the staff reviews the match request submitted and searches for a match in the hospital database.

At block 1024, a determination is made by the staff as to whether a match is found. For example, as described above with respect to FIG. 6 the staff may adjust the filter criteria for locating an exact match.

At block 1026, when a match is found, the staff approves the matching and linking as described above with respect to FIG. 6, and the process proceeds to block 1008.

At block 1028, on the other hand, when a match is not found by the staff, the staff rejects the match request and selects a reason as described above with respect to FIG. 7.

At block 1030, the staff makes a determination as to whether to block the connection component account of the user, such as for making multiple invalid requests, or the like.

At block 1032, when the staff makes a decision to block the account, no more match requests are allowed to be submitted by that account.

At block 1034, as a result of the blocking, a “blocked account” message, or the like may be displayed to the user.

At block 1036, on the other hand, when the staff does not decide to block the account, the staff resets the match attempt limit for the account and thereby allows the patient to submit additional match attempts.

At block 1038, a special reject message may be displayed to the user indicating the reason that the attempt was rejected and possibly providing the user with a solution for use in the next match attempt.

### Process for Manual Matching and Linking

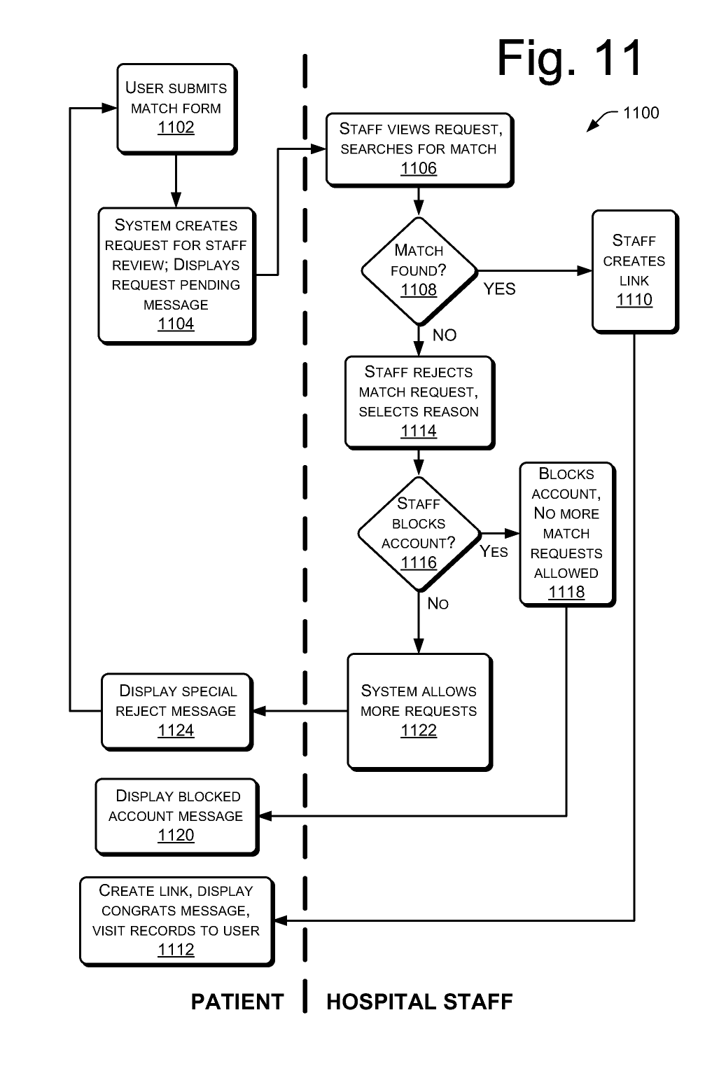

FIG. 11 depicts a block diagram of an example process 1100 for manual matching according to some implementations herein. In the block diagram, the operations are summarized in individual blocks. The operations may be performed in hardware, or as processor-executable instructions (software or firmware) that may be executed by one or more processors. Further, the process 1100 may, but need not necessarily, be implemented using the examples of FIGS. 3-9. Consequently, by way of explanation, and not limitation, the process 1100 is described in the context of the examples of FIGS. 3-9.

At block 1102, the user submits a completed match identification information interface to the connection component, as described above with reference to FIG. 4.

At block 1104, the connection component creates a request for staff review and displays a “request pending” message in a staff review queue.

At block 1106, the staff views the match request submitted and may search for a match in the hospital database. For example, as discussed above with respect to FIG. 6, the connection component may display an interface showing whether or not there is an exact match.

At block 1108, a determination is made by the staff as to whether a match is found. For example, as described above with respect to FIG. 6 the staff may adjust the filter criteria for locating an exact match.

At block 1110, when a match is found the staff approves the matching and linking as described above with respect to FIG. 6, and the process proceeds to block 1112.

At block 1112, when the staff has approved the match, the connection component may create a link between the patient's connection component account record and the patient's health repository account record for linking the patient's hospital visit records to the patient's health repository account record. The connection component may further display a congratulation message or similar type of notification to the user.

At block 1114, on the other hand, when a match is not found by the staff, the staff may reject the match request and select a reason as described above with respect to FIG. 7.

At block 1116, the staff makes a determination as to whether to block the connection component account of the user, such as when the user has made a number of invalid match requests, or the like.

At block 1118, when the staff makes a decision to block the account, no more match requests are allowed to be submitted by that account.

At block 1120, a “blocked account” message may be displayed to the user.

At block 1122, on the other hand, when the staff decides not to block the account, the staff may allow the patient to submit additional match attempts.

At block 1124, a special reject message may be displayed to the user indicating the reason that the attempt was rejected and possibly providing the user with a solution for use in the next match attempt.

### Relationships Between Accounts

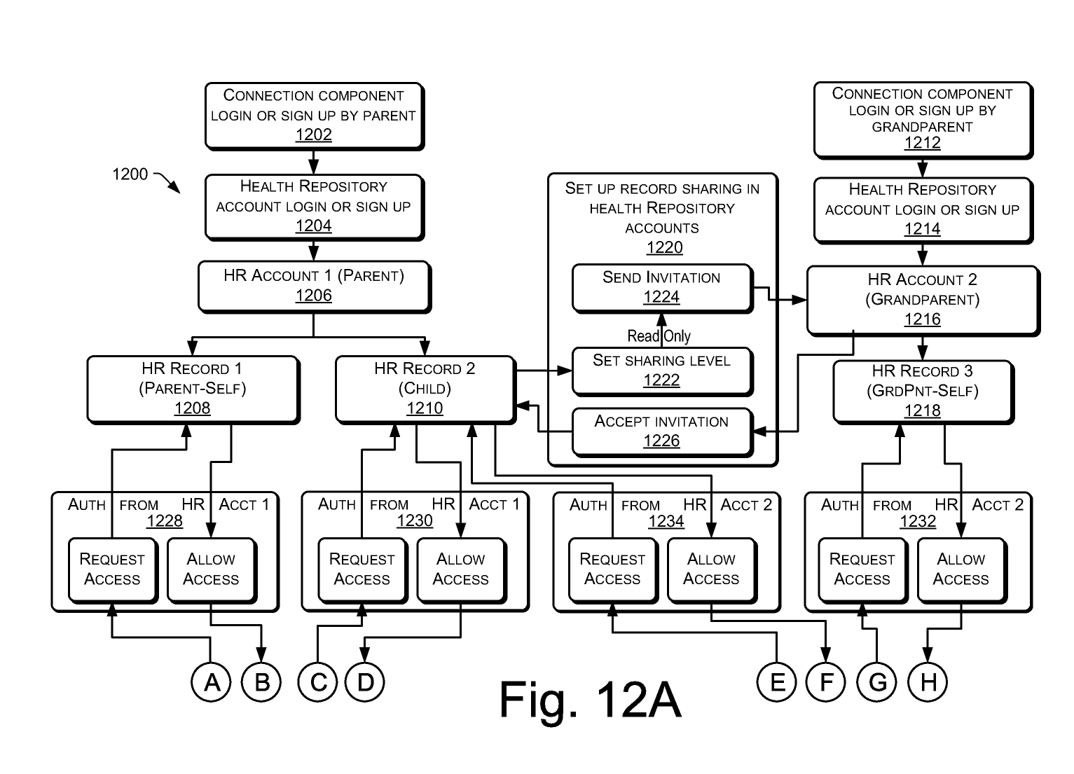

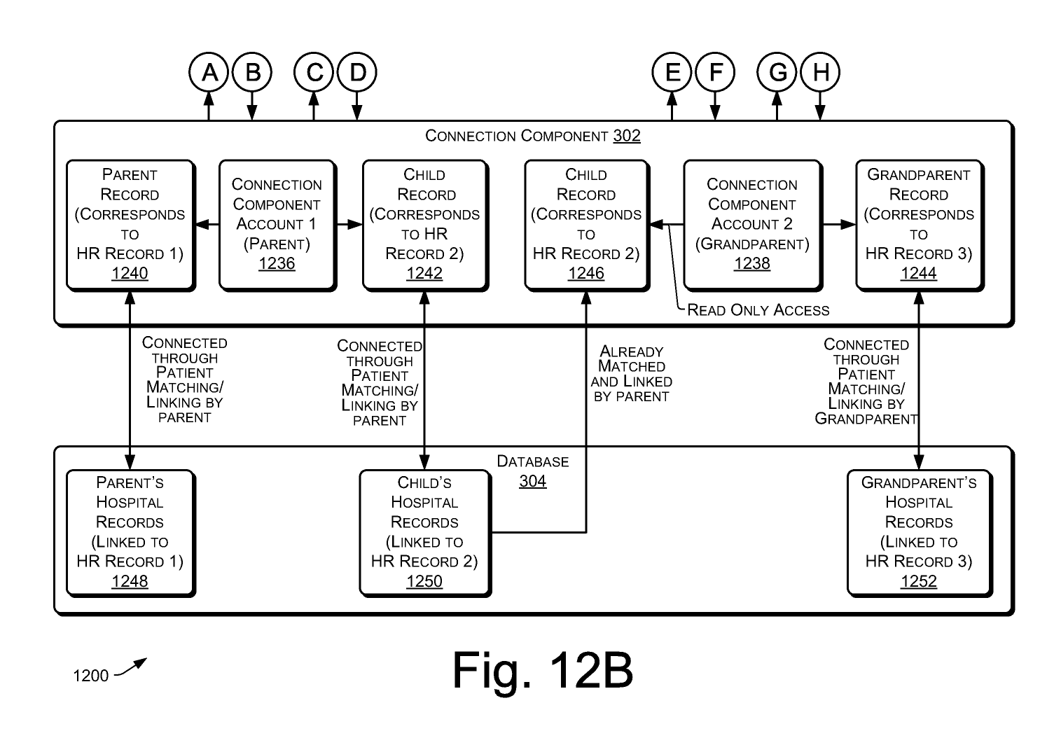

FIGS. 12A-12B depict a block diagram 1200 illustrating an example of relationships between account records maintained in the health information repository 312 and the hospital database 306 according to some implementations. Further, the relationships of block diagram 1200 may, but need not necessarily, be implemented using the examples of FIGS. 3-9. Consequently, by way of explanation, and not limitation, the process 1200 is described in the context of the examples of FIGS. 3-9.

At block 1202, based on the example of FIG. 3B, an individual who happens to be a parent logs in or signs up for an account 338 using the connection component 302 of hospital 308. For example the parent 332 may have a child 334 (i.e., the child in this example) and may also have a parent (i.e., the grandparent 336 in this example).

At block 1204, as part of the account sign up process, the connection component has the parent also perform operations for obtaining an account on the health information repository 312, if the parent does not already have an account. Thus, the connection component may use the authorization for the health information repository 312 as authorization for login to the connection component 302. Further, the order of blocks 1202, 1204 may be reversed.

At block 1206, as a result of block 1204, the parent has a first health repository (HR) account 314-1 (i.e., HR Account 1). Furthermore, as a result of block 1202, the parent also has access to a first account 338 on the connection component 302, but has not yet provided matching and linking information to the connection component for accessing the hospital visit records of the parent in the hospital database 306.

At block 1208, the health repository account of the parent (HR Account 1) has a parent health record 342 (HR record 1) for storing the health information of the parent.

At block 1210, the parent has also included the child in the health repository account 314-1 (HR Account 1), and thus, there is a child health record 346 (HR record 2) included in HR Account 1 for storing the health information of the child. Further, the parent has both read and write access to the health repository account child health record 346 (HR record 2).

At blocks 1212 and 1214, the grandparent also separately signs up for access to the connection component through a separate second account 348 and for a separate health repository account 314-2 (HR Account 2) on the health information repository.

At blocks 1216 and 1218 the separate health repository account in the health information repository created by the grandparent (HR Account 2) has a grandparent health record 352 (HR record 3) for storing the health information of the grandparent. Consequently, the grandparent is able to access the connection component 302 and the health information repository 312 using login credentials and an account that are separate from those of the parent. Further, while the grandparent has access to the connection component 302, the grandparent also has not yet provided matching and linking information to the connection component 302 for accessing the hospital visit records of the grandparent in the hospital database 306.

At block 1220, the parent decides to allow the grandparent to be able to view or access the child's health information. Consequently, the parent sets up record sharing in the health repository account 314-1 to enable the grandparent to access the child's health information. The access may be both read and write access in some implementations, but in this example the access is for read-only access.

At blocks 1222 and 1224, the parent sets the sharing level of the child health record (HR record 2) to read-only with respect to the grandparent, and sends an invitation to the grandparent's health repository account (HR Account 2) for sharing the health record of the child.

At block 1226, the grandparent accepts the invitation to share the record of the child at a read-only sharing level. Consequently, the grandparent is able to view the health information in the child's health record (HR record 2), but is not able to write to the child's record, such as for storing information therein.

At block 1228, as a result of the parent signing up for the health repository (HR) account and the connection component account, the connection component is able to request access and allow access between the records in the health repository account (e.g., HR record 1 of HR Account 1) and corresponding records (i.e., the parent record) in the connection component account. Consequently, the connection component is able to exchange information (i.e., request access, allow access) between the records in the connection component account and the corresponding records in the health repository account. Thus, at block 1230, the connection component is authorized to exchange information with HR record 2 of HR Account 1, and at block 1232, the connection component is authorized to exchange information with HR record 3 of HR Account 2. Further, at block 1234, because HR record 2 is shared with HR Account 2 through the health information repository, the connection component is also authorized to exchange information in a read-only manner with HR record 2 of Account 1 based on the relationship with Account 2.

Referring to FIG. 12B, as a continuation of FIG. 12A, block 1236 represents the connection component account (Connection component account 1) created by the parent in block 1202, and block 1238 represents the connection component account (Connection component account 2) created by the grandparent in block 1212.

Connection component account 1 at block 1236 has a parent record (corresponding to HR record 1) at block 1240 and a child record (corresponding to HR record 2) at block 1242. Similarly, Connection component Account 2 created by the grandparent has a grandparent record (corresponding to HR record 3) at block 1244 and a child record (corresponding to HR record 2) at block 1246. Further, because the grandparent sharing privileges for HR record 2 are limited to read-only in the health repository account, the connection component also limits the grandparent's access to the child record in the connection component account 2.

At block 1248, the parent can use the matching and linking process described above to match and link the parent's hospital records to the parent record and Connection component account 1, and thereby link the parent's hospital records to HR record 1 of the parent's health repository account (HR Account 1).

At block 1250, similarly, the parent can use the matching and linking process to match and link the child's hospital records to the child connection component record, and thereby to HR record 2 of the parent's health repository account (HR Account 1).

At block 1252, the grandparent can use the matching and linking process to match and link the grandparent's hospital records to the grandparent record, and thereby to HR record 3 of the grandparent's health repository account (HR Account 2). Further, because the parent has already matched and linked the child's hospital records to the health repository account of the parent (HR Account 1), the sharing relationship that is established between HR Account 1 and HR Account 2 is given the same status by the connection component as in the health information repository. In this example, since HR Account 2 has read-only status in the health information repository with respect to HR record 2, then read-only status is also granted in the portal account 2 for accessing the child's hospital records. Accordingly, the grandparent is able to view the child's hospital visit records without having to perform patient matching for the child. This trust relationship is mediated through the sharing rules of the health information repository. For example, a read-only account is not able to initiate patient matching, but is able to obtain the benefits of patient linking once the link is in place. Further, under read-only privileges in the connection component, the grandparent is able to create preregistrations for the child, but is not able to save data back into the health repository account. Similarly, while the grandparent is able to view hospital visit records, such as CCRs for the child, the grandparent is not able to copy the CCRs back into the child's health record (HR record 2).

### Data Type for Information Protection

Furthermore, the health information repository may include specific data types that can be used for privacy protection or for use by connection components at their discretion. Thus, within the health repository account a connection-component-specific data type may be used by the connection component 302 to enable the binding of a single patient identifier to multiple online health repository account and health record identifier combinations. For example, when a health repository account record is used for the first time within a connection component account, that record will be updated with the connection-component-specific data type and optionally digitally signed by the hospital. Upon all future use of the health repository record by a connection component account, the connection-component-specific data type specific to the hospital will have its signature validated prior to use. If the signature of the application-specific data type is found to be invalid, the current value of the application-specific data type may be discarded and a new value may be generated, signed and updated into the record of the health repository account.

In addition, message authentication may be used to detect any tampering with both the data and messages checksums, so as to introduce changes while seemingly preserving the message's integrity. Message integrity may be used to indicate that the data has not been changed, destroyed or lost in an unauthorized manner. Furthermore, signer authentication may be used to indicate that the identity of the signer is as claimed so that a level of trust can be inferred from the information being consumed.

The connection-component-specific data type is an object populated by the connection component with information meaningful to the connection component for managing relationships between patients' records and accounts in the health repository, the connection component and the hospital database. Consequently, the connection-component-specific data type can be used to manage the relationships between accounts for enabling records under each account to be separately identified and managed. Thus, the connection-component-specific data type enables creation of a globally unique identifier for each record that can be used to mark the record so that the connection component can recognize the record, even if the record accesses the connection component from a different account than the account the record was in when the identifier was generated.

The identifiers may also be secured so that only the connection component can access the information and digitally signed the authenticity of the information stored can be verified. For instance, the connection-component-specific data type may be used by the connection component to place an identifier for each record and each account in the connection component, and an identifier for each corresponding visit record in the database 306. For example, the child record 344 in the connection component 344 can be identified by a child record identifier and an account identifier, while the child visit records 358 have a separate identifier. Thus, based on the identifiers, the connection-component-specific data type is used to help direct patient visit records to the correct record in the health information repository.

As an example, if the child health record 346 is moved from first health repository account 314-1 (parent) to the second health repository account 314-2 (grandparent), the record 346 is still recognized as being connected to the child record 344 and the child visit records 358. Thus, the connection-component-specific data type can be used to protect the child visit record from being matched and linked to more than one record in the health repository or in the connection component.

Furthermore, suppose that the grandparent obtains an account at the connection component prior to the parent and uses the child's record to create a pre-registration for the child before the child's record is matched and linked. Then the parent creates a connection component account for the child. Through the connection-component-specific data type identifiers, the child record created by the parent and the child record created by the grandparent are able to be identified as belonging to the same person based on the relationship of the records identified in the health repository account. This enables merging of the pre-registrations that were performed by the grandparent with the patient match details performed by the parent to unify the information for the child record. Further, the grandparent is able to avoid having to perform matching as the sharing relationship established between accounts in the health information repository can be supported by the connection component.

### Example System Architecture

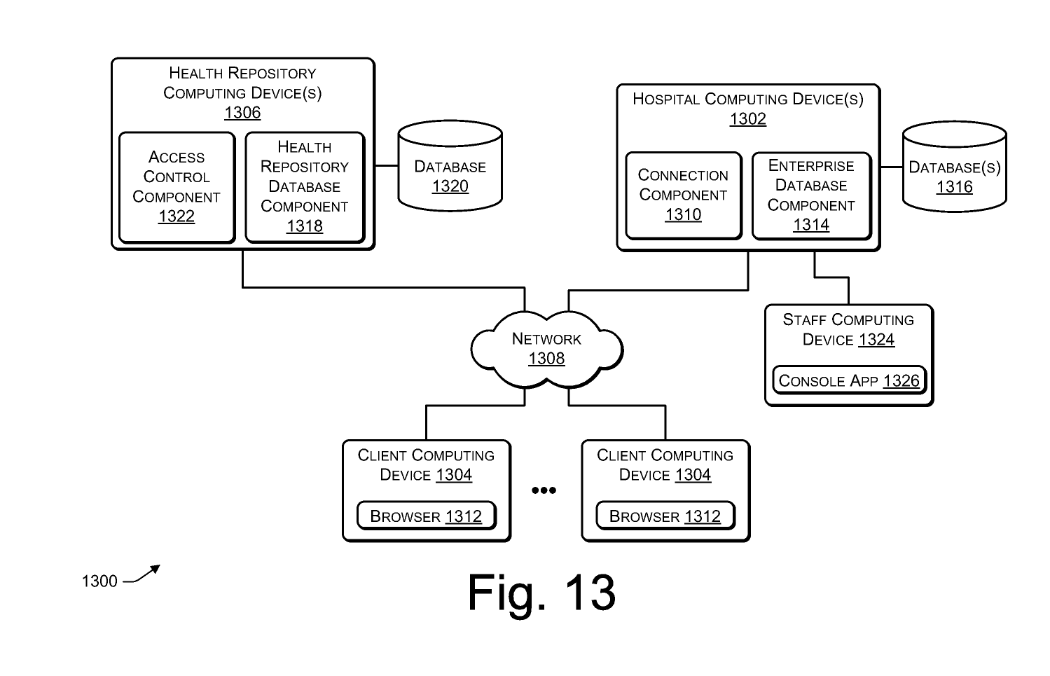

FIG. 13 illustrates a block diagram of an example system architecture 1300 for explanation purposes. In the illustrated example, architecture 1300 includes at least one hospital computing device 1302 able to communicate with a plurality of client computing devices 1304 and at least one health repository computing device 1306 through a network 1308. For example, network 1308 may be the Internet or other suitable communication network enabling communication between hospital computing device 1302, client computing devices 1304 and health repository computing device 1306. Hospital computing device 1302 may include a connection component 1310 able to be accessed by browsers 1312 on client computing devices 1304. For example, in some implementations, connection component 1310 may correspond to connection component 106, 302 described above. Hospital computing device 1302 may also include an enterprise database component 1314 in communication with one or more hospital databases 1316 for obtaining and maintaining patient hospital visit information, as described above. For example, in some implementations, enterprise database component 1314 may correspond to databases 108, 304 described herein. Further, in some implementations, connection component 1310 may be on a separate computing device from enterprise database component 1314, and/or in a separate physical location.

The client computing devices 1304 may include a variety of user computing devices, patient computing devices, care provider computing devices, and the like, used by users, patients and care providers for accessing the connection component 1310 on the hospital computing device 1302 and/or for accessing health repository computing device 1306. For example, client computing devices 1304 may be any of personal computers, laptops, smartphones, mobile devices, server computers, or other suitable computing devices able to access the hospital computing device 1302 and the health repository computing device 1306, such as over the Internet via the World Wide Web.

In addition, health repository computing device 1306 may include a health information repository component 1318 for providing health repository accounts to users. Health repository database component 1318 may be in communication with a health information database 1320 that contains the health information of multiple users. Health repository computing device 1306 may also include an access control component 1322 for controlling access to the health repository database component 1318 and for protecting the private information contained therein.

Further, in some implementations one or more staff computing devices 1324 may be in communication with the hospital computing device 1302, such as by a local area network (LAN), wide area network (WAN), the Internet, or the like. Staff computing device 1324 may include a console application 1326 able to communicate and interact with the connection component 1310, for enabling the staff to perform the functions described herein, such as assisting in patient matching and linking, allowing or removing connections of care providers, and the like. In some implementations, console application 1326 may be a web browser, web application, or the like. In other implementations, console application may be a proprietary application configured specifically for communication with connection component 1310.

While the foregoing sets forth an example of a system in which the connection component and hospital visit information sharing described above may be implemented, this is merely one example of a possible system, and implementations herein are not limited to any particular system configuration. Accordingly, the connection component and information sharing scenarios disclosed herein may be implemented in any suitable system or environment.

### Example Hospital Computing Device

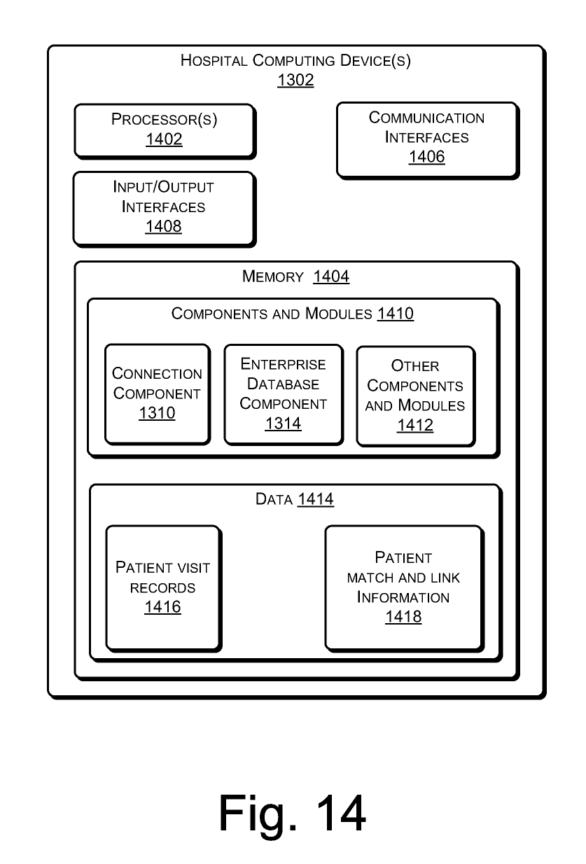

FIG. 14 illustrates an example of the hospital computing device 1302 that can be used to implement the components and modules for patient information access and sharing described herein. In the illustrated example, hospital computing device 1302 includes at least one processor 1402 communicatively coupled to a memory 1404, one or more communication interfaces 1406, and one or more input/output interfaces 1408. The processor 1402 can be a single processing unit or a number of processing units, all of which may include multiple computing units or multiple cores. The processor 1402 may be implemented as one or more microprocessors, microcomputers, microcontrollers, digital signal processors, central processing units, state machines, logic circuitries, and/or any devices that manipulate signals based on operational instructions. Among other capabilities, the processor 1402 can be configured to fetch and execute computer-readable instructions stored in the memory 1404 or other non-transient computer-readable storage media.

The memory 1404 can include any computer-readable storage media known in the art including, for example, volatile memory (e.g., RAM) and/or non-volatile memory (e.g., flash, etc.), mass storage devices, such as hard disk drives, solid state drives, removable media, including external drives, removable drives, floppy disks, optical disks (e.g., CD, DVD), storage arrays, storage area networks, network attached storage, or the like, or any combination thereof. The memory 1404 stores computer-readable processor-executable program instructions as computer program code that can be executed by the processor 1402 as a particular machine programmed for carrying out the processes and functions described according to the implementations herein.

The communication interfaces 1406 facilitate communication between the hospital computing device 1302 and the client computing devices 1304, the health repository computing device 1306, and the staff computing device 1324. The communication interfaces 1406 can facilitate communications within a wide variety of networks and protocol types, including wired networks (e.g., LAN, cable, etc.) and wireless networks (e.g., WLAN, cellular, satellite, etc.), the Internet and the like, any of which may correspond to the network 1308. Communication interfaces 1406 can also provide communication with external storage (not shown), such as in a storage array, network attached storage, storage area network, or the like, for maintaining the database(s) 1316. In some implementations, the hospital computing device 1302 can receive communications from a client computing device 1304, the health repository computing device 1306, and/or the staff computing device 1324 via the communication interfaces 1406, and the hospital computing device 1402 can send communications back to the client computing devices 1304, the health repository computing device 1306, and/or the staff computing device 1324 via the communication interfaces 1406.

Memory 1404 includes a plurality of components and program modules 1410 stored therein and executable by processor 1402 for carrying out implementations herein. Components and program modules 1410 include the connection component 1310 and the enterprise database component 1314. Memory 1404 may also include a number of other components and modules 1412, such as an operating system, communication software, drivers, or the like. Additionally, while the connection component 1310 and the enterprise database component 1314 are shown in the examples as being on the same computing device, in other implementations, these components may be operated on one or more separate computing devices.

Memory 1404 also includes data 1414 that may include patient visit records 1416 and patient match and link information 1418. Patient match and link information 1418 may include information such as connection component account information, and matching and linking information for linking the patient visit records to health repository accounts. Further, while an example of an implementation of a hospital computing device architecture has been described, it will be appreciated that other implementations are not limited to the particular architecture described herein.

### Example Health Repository Computing Device

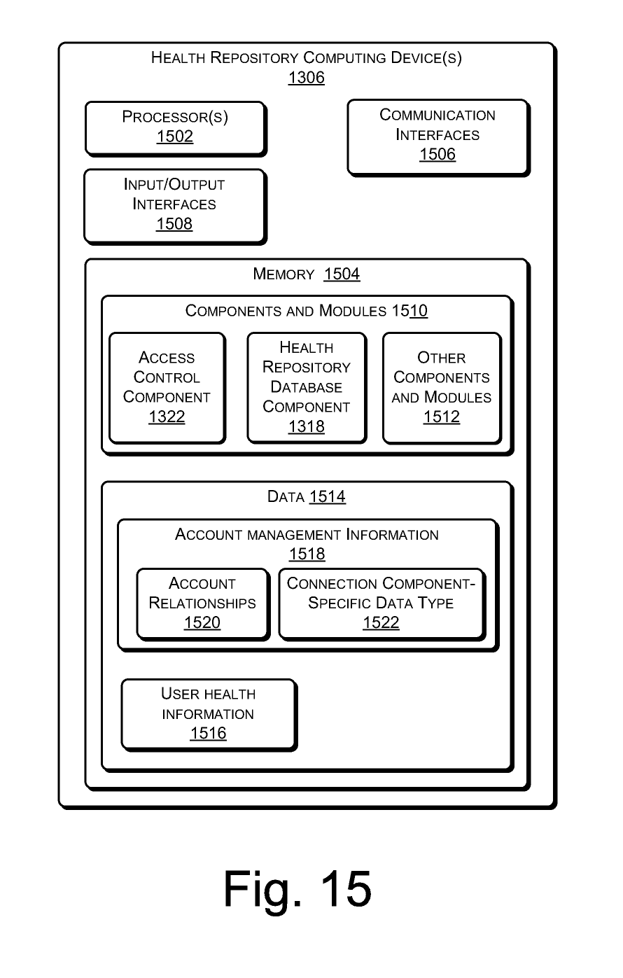

FIG. 15 illustrates an example of health repository computing device 1306 that can be used to implement the health repository accounts described herein. In the illustrated example, health information repository computing device 1306 includes at least one processor 1502 communicatively coupled to a memory 1504, one or more communication interfaces 1506, and one or more input/output interfaces 1508. The processor 1502 can be a single processing unit or a number of processing units, all of which may include multiple computing units or multiple cores. The processor 1502 may be implemented as one or more microprocessors, microcomputers, microcontrollers, digital signal processors, central processing units, state machines, logic circuitries, and/or any devices that manipulate signals based on operational instructions. Among other capabilities, the processor 1502 can be configured to fetch and execute computer-readable instructions stored in the memory 1504 or other non-transient computer-readable storage media.

The memory 1504 can include any computer-readable storage media known in the art including, for example, volatile memory (e.g., RAM) and/or non-volatile memory (e.g., flash, etc.), mass storage devices, such as hard disk drives, solid state drives, removable media, including external drives, removable drives, floppy disks, optical disks (e.g., CD, DVD), storage arrays, storage area networks, network attached storage, or the like, or any combination thereof. The memory 1504 stores computer-readable processor-executable program instructions as computer program code that can be executed by the processor 1502 as a particular machine programmed for carrying out the processes and functions described according to the implementations herein.

The communication interfaces 1506 facilitate communication between the health repository computing device 1306 and the client computing devices 1304 and the hospital computing device 1302. The communication interfaces 1506 can facilitate communications within a wide variety of networks and protocol types, including wired networks (e.g., LAN, cable, etc.) and wireless networks (e.g., WLAN, cellular, satellite, etc.), the Internet and the like, any of which may correspond to the network 1308. Communication interfaces 1506 can also provide communication with external storage (not shown), such as in a storage array, network attached storage, storage area network, or the like, for maintaining the database 1320. In some implementations, the health information repository computing device 1306 can receive communications from a client computing device 1304 and the hospital computing device 1302 via the communication interfaces 1506, and the health information repository computing device 1506 can send communications back to the client computing devices 1304 and the hospital computing device 1302 via the communication interfaces 1506.

Memory 1504 includes a plurality of components and program modules 1510 stored therein and executable by processor 1502 for carrying out implementations herein. Components and program modules 1510 include the health information repository component 1318 and the access control component 1322. Memory 1504 may also include a number of other components and modules 1512, such as an operating system, communication software, drivers, or the like.

Memory 1504 also includes data 1514 that may include user health information 1516 and account management information 1518. Account management information 1518 may include account relationships 1520, such as information such which accounts in the health information repository are able to share records, or the like. Account management information also may include identification of a connection-component-specific data type 1522. As mentioned above, the connection-component-specific data type 1522 is used to enable binding of a connection component patient identifier to multiple health repository accounts and health repository record identifiers for enabling the patient information to be delivered to the correct health record in the health information repository. Further, while an example of an implementation of a hospital computing device architecture has been described, it will be appreciated that other implementations are not limited to the particular architecture described herein.

### Client Computing Device

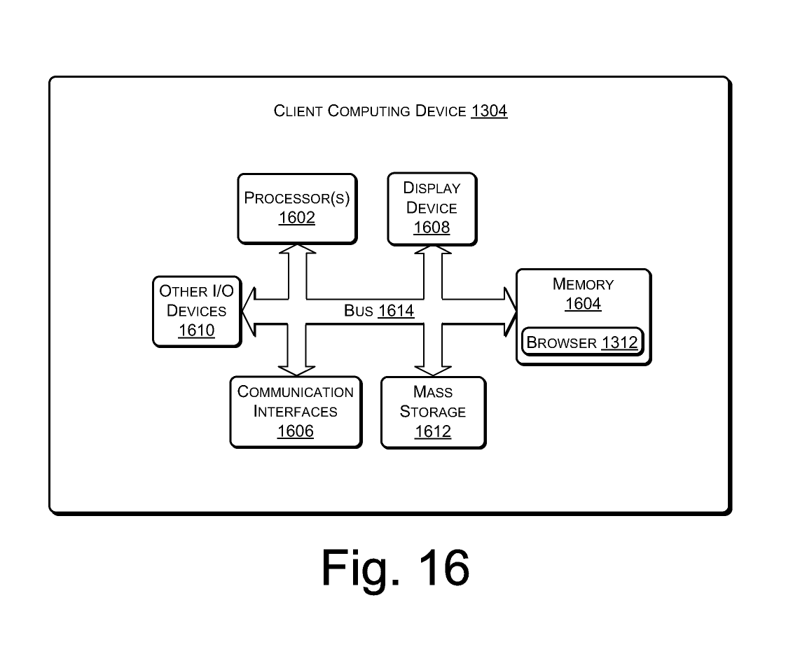

FIG. 16 illustrates an example configuration of a client computing device 1304 that can be used by the patients, care providers, or the like, such as for interacting with the connection component and accessing information on the hospital computing device and/or the health information repository computing device. A configuration similar to client computing device 1304 illustrated in FIG. 16 may also be used for staff computing device 1324. The client computing device 1304 may include at least one processor 1602, a memory 1604, communication interfaces 1606, a display device 1608, other input/output (I/O) devices 1610, and one or more mass storage devices 1612, all able to communicate through a system bus 1614 or other suitable connection.

The processor 1602 may be a single processing unit or a number of processing units, all of which may include single or multiple computing units or multiple cores. The processor 1602 can be implemented as one or more microprocessors, microcomputers, microcontrollers, digital signal processors, central processing units, state machines, logic circuitries, and/or any devices that manipulate signals based on operational instructions. Among other capabilities, the processor 1602 can be configured to fetch and execute computer-readable instructions or processor-accessible instructions stored in the memory 1604, mass storage devices 1612, or other computer-readable storage media.

Browser 1312 described above may be maintained in memory 1604 and executed on processor 1602. Memory 1604 and mass storage devices 1612 are examples of computer-readable storage media for storing instructions which are executed by the processor 1602 to perform the various functions described above. For example, memory 1604 may generally include both volatile memory and non-volatile memory (e.g., RAM, ROM, or the like). Further, mass storage devices 1612 may generally include hard disk drives, solid-state drives, removable media, including external and removable drives, memory cards, Flash memory, floppy disks, optical disks (e.g., CD, DVD), or the like. Both memory 1604 and mass storage devices 1612 may be collectively referred to as memory or computer-readable storage media herein. Memory 1604 is capable of storing computer-readable, processor-executable program instructions as computer program code that can be executed on the processor 1602 as a particular machine configured for carrying out the operations and functions described in the implementations herein.

The client computing device 1604 can also include one or more communication interfaces 1606 for exchanging data with other devices, such as via a network, direct connection, or the like, as discussed above. The communication interfaces 1606 can facilitate communications within a wide variety of networks and protocol types, including wired networks (e.g., LAN, cable, etc.) and wireless networks (e.g., WLAN, cellular, satellite, etc.), the Internet and the like.

A display device 1608, such as a monitor may be included in some implementations for displaying information to users. Other I/O devices 1610 may be devices that receive various inputs from a user and provide various outputs to the user, and can include a keyboard, remote controller, a mouse, audio input/output devices, and so forth. Further, while an example client computing device configuration and architecture has been described, other implementations are not limited to the particular configuration and architecture described herein.

### Example Environments

The example computing devices described herein are merely examples of suitable computing devices for some implementations and are not intended to suggest any limitation as to the scope of use or functionality of the architectures and frameworks that can implement the processes, components and features described herein. Neither should the computing devices described be interpreted as having any dependency or requirement relating to any one or combination of the components illustrated in the implementations herein. Thus, implementations herein are operational with numerous general purpose and special-purpose computing systems, environments or configurations, or other devices having processing capability.

Additionally, the components herein can be employed in many different environments and situations, and are not limited to use in a hospital computing device. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer-readable storage devices. Thus, the processes, components and modules described herein may be implemented by a computer program product. The computer program product may include computer-readable media having a computer-readable program code embodied therein. The computer-readable program code may be adapted to be executed by one or more processors to implement the processes, components and/or modules of the implementations described herein. The terms “computer-readable media,” “processor-accessible media,” or the like, refer to any kind of non-transient machine-readable storage medium for retaining information, and can include the various kinds of storage devices discussed above.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described in connection with the implementations is included in at least one implementation, and the appearances of these phrases in various places in the specification are not necessarily all referring to the same implementation. Additionally, in the description, numerous specific details are set forth in order to provide a thorough disclosure. However, it will be apparent to one of ordinary skill in the art that these specific details may not all be utilized in all implementations. In other circumstances, well-known structures, materials, circuits, processes and interfaces have not been described in detail or are illustrated in block diagram form, so as to not unnecessarily obscure the disclosure.

### CONCLUSION

Implementations herein enable a user to provide identification information to a connection component that positively and uniquely identifies the user for obtaining access to a secure database. The connection component may apply a matching process that compares the identification information provided by the user with known user identity information obtained from the secure database. Additionally, following the matching of the user with the user identity information, some implementations herein provide for linking of a connection component account and an external account of the user with the user's information contained in the secure database. The linking to the external account enables a flow of information between the user information contained in the secure database and the user's external account. The linking of the connection component account enable the user to access and view the information contained in the secure database.

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A computer-implemented method comprising:
implementing, by a processor, a connection component providing electronic access to hospital visit records maintained in a hospital database;
creating, by the connection component, an account for a patient, the account created by the connection component corresponding to a health repository account of the patient maintained by a health information repository;
establishing, by the connection component, an identity of the patient for permitting access to hospital visit records of the patient; and
linking the hospital visit records of the patient to the health repository account of the patient to provide the hospital visit records to the health repository account.

2. The method according to claim 1, the establishing the identity of the patient comprising:
obtaining patient identification information from the patient for comparison with identity information for the patient maintained in the hospital database; and
executing automated matching that establishes the identity of the patient when there is a match between the identification information obtained and the identity information for the patient maintained in the hospital database.

3. The method according to claim 1, the establishing the identity of the patient further comprising:
obtaining identification information for the patient for comparison with identity information for the patient maintained in the hospital database;
when there is not a match between the identification information obtained for the patient and the identity information for the patient maintained in the hospital database, performing manual matching comprising:
providing a filter having selectable identity matching criteria corresponding to the identification information received for the patient; and
deselecting one or more identity matching criteria by using the filter to obtain a broader search for effecting a match between the identification information received for the patient and the identity information maintained in the database.

4. The method according to claim 1, wherein the patient is a first patient and the health repository account has a first record for the first patient, the health repository account having a second record for a second patient, the account created by the connection component having a corresponding first record and second record, further comprising:
providing, by the connection component, an interface for the first patient to manage the first record and the second record in the connection component account.

5. The method according to claim 1, further comprising using a connection-component-specific data type recognized by the health repository to manage a relationship between the account created by the connection component, the health repository account and the hospital visit records of the patient.

6. The method according to claim 5, wherein the health repository account is a first health repository account having a health record for the patient, the account created by the connection component having a corresponding record, further comprising:
establishing a sharing relationship for sharing the health record between the first health repository account and a second health repository account, the sharing relationship being supported by the connection component when a user of the second health component account attempts to access the hospital visit records of the patient.

7. The method according to claim 6, further comprising:
using a connection-component-specific data type to support the sharing relationship, the connection-component-specific data type enabling binding of a single patient identifier to multiple health repository account identifiers and health record identifiers.

8. A computing device comprising:
a processor in communication with computer-readable storage media;
a connection component, maintained in the computer-readable storage media and executed on the processor, to generate an interface for display to a connection component operator, the interface enabling specification of one or more of a plurality of supported fields for multiple identification criteria, wherein the connection component operator specifies at least one of the plurality of supported fields for changing identification information to be requested from a user.

9. The computing device according to claim 8, the interface providing for addition of a custom field for identification criteria, the custom field specifying an identification criterion not included in the supported fields, the connection component operator adding the custom field for changing identification information requested in an identification information interface displayed to a user of the connection component, the identification information interface requesting identification information from the user for establishing an identity.

10. The computing device according to claim 8, the interface further being configured to display fields selectable by the connection component operator for specifying whether the identification information requested from the user is matched to user identity information using automated matching or a manual matching.

11. The computing device according to claim 10, the automated matching comprising comparing identification information received from the user with identity information maintained in a database, and automatically establishing the identity of the user when there is a match between the identification information received from the user and the identity information maintained in the database.

12. The computing device according to claim 10, the manual matching comprising a match request interface displayed to the connection component operator, the match request interface displaying identification information received from the user for comparison with displayed identity information maintained in the database.

13. The computing device according to claim 12, the manual matching further comprising a filter displayed in the match request interface having selectable identity matching criteria corresponding to the identification information received from the user, one or more identity matching criteria being de-selectable using the filter to locate additional possible matches.

14. The computing device according to claim 13, wherein the selectable identity matching criteria in the filter is automatically changed as a result of the connection component operator selecting at least one of the plurality of supported fields for changing the identification information to be requested from a user.

15. The computing device according to claim 8, wherein the connection component is in communication with a database containing user information, the connection component being configured to:
request selected identification information in an interface presented to the user for obtaining the selected identification information from the user;
establish an identity of the user by matching the selected identification information obtained from the user with identity information for the user maintained in the database; and
responsive to establishing the identity of the user, link an external account of the user to the user information in the database for providing access to the user information in the database through the external account.

16. A method comprising:
implementing, by a processor, a connection component providing electronic access to patient information maintained in a database;
creating, by the connection component, a first account corresponding to a first health repository account in a health information repository for enabling access to the patient information through the first account;
creating by the connection component a second account, the second account corresponding to a second health repository account in the health information repository, wherein there is a sharing relationship established at the health information repository between the first health repository account and the second health repository account; and
supporting, by the connection component, the sharing relationship for permitting the second account to access the patient information accessible in the database through the first account.

17. The method according to claim 16,
wherein the sharing relationship in the health information repository gives the second health repository account read-only access to information in the first health repository account,
wherein the second account created by the connection component is provided read-only access to the patient information accessible in the database through the first account.

18. The method according to claim 16, wherein there is a first connection component record in the first account created by the connection component and a corresponding first health record in the first health repository account, further comprising:
using a connection-component-specific data type to create globally unique identifiers for the first connection component record and the first health record for managing a relationship between the first connection component record and the first health record.

19. The method according to claim 16, further comprising:
establishing, by the connection component, an identity of a patient corresponding to the patient information in the database for permitting the access the patient information; and
responsive to establishing the identity of the patient, linking the patient information in the database to the first health repository account for providing a flow of the patient information to the first health repository account.

20. The method according to claim 19, wherein an attempt by the second account to establish an identity of the patient corresponding to the patient information in the database for permitting the access the patient information is denied by the connection component based on linking of the patient information already being established with the first health repository account.
